(19) United States
(12) Patent Application Publication
(10) Pub. No.: US 2026/0107953 A1
(43) Pub. Date: Apr. 23, 2026

(54) PROCESS TECHNOLOGY AND METHOD FOR PREPARING BIO-INGREDIENTS, FOODS AND BEVERAGES IN ABSENCE OF OXYGEN

(71) Applicant: Luiz De Miranda, Waterloo (CA)

(72) Inventor: Luiz De Miranda, Waterloo (CA)

(21) Appl. No.: 19/420,007

(22) Filed: Dec. 15, 2025

Related U.S. Application Data
(60) Provisional application No. 63/707,040, filed on Oct. 14, 2024.

(51) Int. Cl. A21D 8/06; A21B 3/04; A21D 13/24; A21D 15/02; A23B 45/00; A23F 5/04; A23F 5/08; A23F 5/14; A23G 1/00; A23G 1/02; A23G 1/06; A23N 12/10; A23N 12/12

(52) U.S. Cl. CPC A21D 8/06; A21B 3/04; A21D 13/24; A21D 15/02; A23B 45/00; A23F 5/04; A23F 5/08; A23F 5/145; A23G 1/002; A23G 1/02; A23G 1/06; A23N 12/10; A23N 12/125

(57) ABSTRACT

A method and processing technology for preparing baked products from raw materials is disclosed. The method includes at least one baking or roasting step in which the raw materials are processed in the absence of atmospheric air, achieved through a vacuum, vacuum-compensated, or pressure—the latter two employing an inert atmosphere. A sealed rotary roasting drum (or processing compartment) is supplied with pre-heated inert gas while heating and rotating the raw materials, and the inert gas is optionally recycled for reuse. Additional unit operations such as milling, cooling, spraying, extraction, and storage are also performed in the absence of atmospheric air, to preserve product quality and prevent oxidation. Optional steps include cryogenic pre-milling, sweetener addition to generating a “torrefacto” effect, and supercritical fluid extraction of oils for later incorporation into the baked products. The disclosed technology enables continuous production of baked products with improved aroma, stability, and self-life, by maintaining an oxygen-free environment throughout processing.

### CROSS REFERENCE TO RELATED APPLICATIONS

This application claims priority from a U.S. Provisional Patent Appl. No. 63/707,040, filed on Oct. 14, 2024, which is incorporated herein by reference in its entirety.

### FIELD OF INVENTION

The present invention relates to the process technology and method for preparing bio-ingredients, beverages and/or food products, and more particularly, the present invention relates to modified process technology and method of preparing baked,—and/or roasted—prepared bio-ingredients, including their food or beverage derivatives, and other food products, done entirely in the absence of oxygen.

### BACKGROUND

Baking is a widely used method for preparing food products both in residential and commercial settings. Baking and Roasting both refer to cooking using dry heat, but differ in temperatures, but both the terms are interchangeable when used herein. Pastryiety of food products, infusion-based beverages, condiments, and the like are prepared by baking, including Breads, Buns & Breadsticks; Buns/(Hard) Bread Rolls; Cakes; Pizzas & Calzones; Cereals/Breakfast Cereals; Pies (Salted, Savory and Sweet), Torte & Tarts; Bagels; Ready Meals; Snacks (Salted, Savory and Sweet); Muffins; Viennoiserie: (Croissants, Brioche, Puff, and other Pastries); Baked Doughnuts; Baked Chips; Pretzels; Biscuits: (Cookies & Crackers); Pastries specialties: (Salted, Savory and Sweet); Crispy Breads; Granolas & Mueslis; Flatbreads; Pita Breads; Macaroons; Twice-baked Foods; and Other Baked-Goods (e.g., empanadas). It also includes different kinds of edible items that are prepared or could be prepared using baking and are referred to herein as “Bio-ingredients” in general.

Commercial roasters typically operate under atmospheric conditions, hence utilizing the oxygen component (around 21%) of the atmospheric air,—both directly (air exposure, combustion process) and indirectly (combustion process), to conduct the roasting process. They are typically are employed in the preparation of numerous types of traditionally roasted-based food products, such as: edible roots: potato, ginger, and the like; leaves: for the preparation of edible infusions, like tea, and the like; vegetables: cauliflower, onions, squashes, turnips, carrots, and the like; meats: beef, pork, chicken, turkey, lamb, mutton, and the like; salads: vegetable, garden, beet, chickpeas, and the like; specialty dishes: cabbages, garlic, chicken, and the like; snacks: nuts, beans, roots, fruits, bakery items, and the like; chips: potato, banana, and the like; desserts; breakfast cereals & mueslis; cheeses; fruits: pear, apple, banana, tomato, and the like; bakery items; seafoods; and other specialties: mushroom, and the like. It's generally assumed that the presence of heated oxygen is either beneficial for eliminating off-flavors, or does not cause harm to foods undergoing thermolysis. However, it has been established that baking under atmospheric air leads to destruction of many nutritional constituents, and generation of chemicals that may be harmful for human health. For selected roast-based ingredients & products, conventional milling techniques, when it is part of the process, can further exacerbate the oxidation process, by increasing the exposed surface area of, for example, the beans,—particularly during the crushing or milling process to the heated air. This is due to the extensive flow of heated air, which interacts with the greatly enlarged surface area of the milled bean particles,—further compromising the product's shelf life.

The overall complex oxidation process undergone, among other components, primarily affecting the P.U.F.A.-type food oils (such as the case of natural coffee oil present in the roasted bean), by subjecting the oil to a lipid peroxidation, through mechanisms of hydrogen abstraction, formation of conjugated diene, followed by oxygen uptake, due to several factors, including the complex oxidation process which primarily affects P.U.F.A.-type oils, such as natural coffee oil present in the roasted bean.

These poly-unsaturated oils undergo lipid peroxidation due to several factors, including the presence of oxygen and free radicals, pro-oxidants, high temperature conditions, moisture content over 2%, and presence of catalysts like Fe, Cu, Mg, Ni, and others. This results in the formation of peroxyl radicals, which accelerate the initiation process of coffee oil oxidation, making it irreversible, self-replicating, and self-accelerated. Furthermore, it culminates in shortage of potential shelf-life of the food and affecting the health of their prospective consumers.

The consequence of the above is the formation of peroxyl radicals that are self-replicated through sequence and cycles of oxidative reactions, with the initiation- and acceleration-process of coffee oil oxidation. Once it is established, the logical sequence of events passes through propagation and termination of the oxidative reactions, which in their turn, make the oxidation process irreversible, self-replicating, and self-accelerated.

Subsequent milling of the product can accelerate the oxidation process, especially when the particles are unprotected, and/or conducted in the presence of atmospheric oxygen (air). For example, when products are milled to an average particle size of around 20 microns, 1 g of the product equates to about 100 sq. m. (or closer to ca. 1,076 sq. ft.) of total surface area of the particles. Thus, the large volume of heated air incorporated in the process, of which ca. of 21% is oxygen, significantly interacts with coffee particles, further compromising the product's shelf life.

International commercialization standards for bio-ingredients, and primary beneficiaries of this patent encompasses: green coffees, cocoa beans, edible nuts, other roasted-based bio-ingredients & their derivative food and/or beverage products, such as tea leaves, and other drinkable infusion of herbs, which define and accept certain types and maximum numbers of defects as “acceptable” for commercialization and/or human consumption. However, even a few % of quality defects (normally present in commercially acceptable bio-ingredients) can negatively impact the final quality of commercially graded products, as these defects are amplified in the finished products (e.g., whenever beans are milled) and can accelerate the overall degradation process, thereby shortening their potential intrinsic qualities and shelf lives.

The term baking, as used herein, also encompasses roasting, and refers to heating using dry-heat in an enclosure. The term bio-ingredients include food products, beverages, and other edible items. Examples of bio-ingredients include whole- or partial beans, nuts, or herb-derived “liquors” (“extractables” or “masses”), or to other edible bio-ingredients that are typically consumed in baked- or roasted form; and also encompass bio-ingredients prepared in various forms, such as: in liquid, paste, powder, infusions and/or other water-based or oil-based soluble/dispersible forms.

### SUMMARY OF THE INVENTION

The following provides a simplified summary of one or more embodiments of the present invention, to facilitate a basic understanding of its features and advantages. This summary is not an exhaustive overview of all contemplated embodiments, and is not intended to identify essential elements, nor define the full scope of the invention. It merely introduces certain concepts that are described in greater detail across the subsequent sections.

The principal object of the present invention is therefore directed to a process technology and a method for preparing bio-ingredients through baking- or roasting processes, while preserving, as much as possible, the constitution of said bio-ingredients. The disclosed baking or roasting processes, therefore, result in bio-ingredients and food- or beverage products with improved nutritional value, and/or extended shelf life.

Another object of the present invention is that the system, processing technology and method described in this patent application can fundamentally protect delicate and heat- and/or oxygen-sensitive bio-ingredients, from imparting immediate and/or long term deleterious chemical, physical, physical-chemical, safety concerns, nutritional and/or rheological changes in those bio-ingredients and/or food & beverage-related products, thus compromising quality, safety, shelf-life, sensorial (such as organoleptic) and/or nutritional properties of these bio-ingredients under basic consideration.

Another object of the present invention is to improve the overall quality and extend the shelf-life of the bio-ingredients processed.

Still another object of the present invention is that a wide variety of bio-ingredients and food & beverage-related products in different physical forms can be processed.

Yet another object of the present invention is that the shelf-life of the bio-ingredients and food & beverage-related products can be improved.

A further object of the present invention is to enhance convenience of preparation.

Still a further object of the present invention is that the yield can be improved.

Yet a further object of the present invention is that the invention facilitates extended shelf-life, storage and utilization.

In one aspect, the disclosed is a system that includes a specially Modified Vacuum or pressurized oven, with- or without the utilization of Inert and/or noble gas(es) atmosphere. The disclosed system can be operated at Normal Atmospheric Pressure Equivalent (N.A.P.E.), and/or both under- or over-pressurized processing conditions,—provided it is conducted in the absence of atmospheric oxygen of the air.

In one aspect, the disclosure is a process of baking that is entirely carried out in the absence of atmospheric oxygen (air), in a closed or semi-closed loop process environment, or through other alternative means-provided that the absence of atmospheric oxygen of the air is secured.

In one aspect, disclosed is a process of preparing the bio-ingredients using baking carried out under vacuum; and/or using pressure, or under atmospheric-compensated, by employing the following gases, i.e., inert gas (such as nitrogen (N₂), carbon dioxide (CO₂), superheated steam (S.H.S.), and the like); and/or noble gases (such as helium (He), neon (Ne), argon (Ar), and the like); and/or any other suitable inert and/or noble gases.—alone or in combination, at any feasible partial pressure conditions, authorized for use in direct- and/or indirect contact with the specific bio-ingredients and/or foods herein disclosed, or generally considered as edible, and commercially available. As such, they should be safe for commercial and/or industrial usage, and allowable for processing food- and/or feed-based ingredients and/or products; and, that they can be utilized as an: in-process component; and/or to secure the absence of atmospheric oxygen (air) in direct contact with the bio-ingredients and/or foods; and/or as heat-transferring medium.

In one aspect, the disclosed is a process of coating bio-ingredients particles being transformed into baked or roasted bio-ingredients, and/or foods, with the usage of anti-oxidative food-grade coatings.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a simplified block flow diagram (B.F.D.) of bio-ingredient's process in which the bio-ingredients are “green” (or crude) beans and the equipment operates under N.A.P.E. (ambient conditions), according to various aspects of the present disclosure.

FIG. 2 is a simplified block flow diagram (B.F.D.) of bio-ingredient's process in which the equipment operates under inert gas, refrigerated inert gas, and/or cryogenic gas conditions, according to various aspects of the present disclosure.

FIG. 3 illustrates a simplified block flow diagram (B.F.D.) of the process and sketch of the closed-loop, inert gas coffee roaster system, according to various aspects of the present disclosure.

FIG. 4 illustrates simplified sketch of the closed-loop, inert gas fluid bed cooling system, utilized for roasted beans, according to various aspects of the present disclosure.

FIG. 5 illustrates a simplified block flow diagram (B.F.D.) of the process and sketch of bio-ingredients' formulated food (mass) processed, using a closed-loop, inert gas-based & special solid phase reactor (S.P.R.) of type modified & special conche (S.C.), or special high pressure extruder (S.H.P.E.),—which can be, (optionally) coupled with an aroma recovery system (A.R.S.), a composite apparatus of steam/S.H.S. distillation/fractionation column (S.D&F.C.)+cryogenic condensation unit (C.C.U.), according to various aspects of the present disclosure.

FIG. 6 illustrates a simplified sketch of the closed-loop, inert gas, ultra-fine roasted & ultrafine milled bio-ingredient's particles being further processed, using fluid bed drying &/or cooling (F.B.D.&/orC.), special agglomerator (S.A.) &/or special coating system (S.C.S.), according to various aspects of the present disclosure.

FIG. 7 illustrates an alternative & novel roasting process: basic lay-out of the installation, using variant type direct-heating through an inert gas, one of the objects of this patent application.

FIG. 8 is a simplified sketch of the modified equipment options for roasted, ultrafine processed bio-ingredients, according to various aspects of the present disclosure.

FIG. 9 illustrates a novel system, specially adapted/modified equipment, processing technology & methods for baked goods.

FIG. 10 illustrates a conceptual, simplified block flow diagram (B.F.D.), indicating a layout of a modified & special vacuum oven (S.V.O.), batch-type, operating with- or without inert(s) gas(es) &/or noble gas(es), and especially designed for baking composite food mass (ou dough), and converting them as baked-good food products.

FIG. 11 illustrates a conceptual, simplified block flow diagram (B.F.D.), indicating the layout of the modified & special vacuum oven (S.V.O.), continuous-type, operating with- or without inert gas(es) &/or noble gas(es), and especially designed for baking edible food preparations, and converting them into baked goods-type: ingredients &/or processed products.

FIG. 12 illustrates a simplified block flow diagram (B.F.D.) of the disclosed extension of the invention, encompassing: (1) basic alternate system, (2) modified and/or specifically adapted processing machinery (including the novel application of a special vacuum oven (S.V.O.),—with- or without inert and/or noble gas(es) compensation,—under- or over pressurized condition, (3) the process technology & (4) method(s)—applied exclusively in the manufacturing of baked goods: their ingredients &/or their processed derivative products.

### DETAILED DESCRIPTION

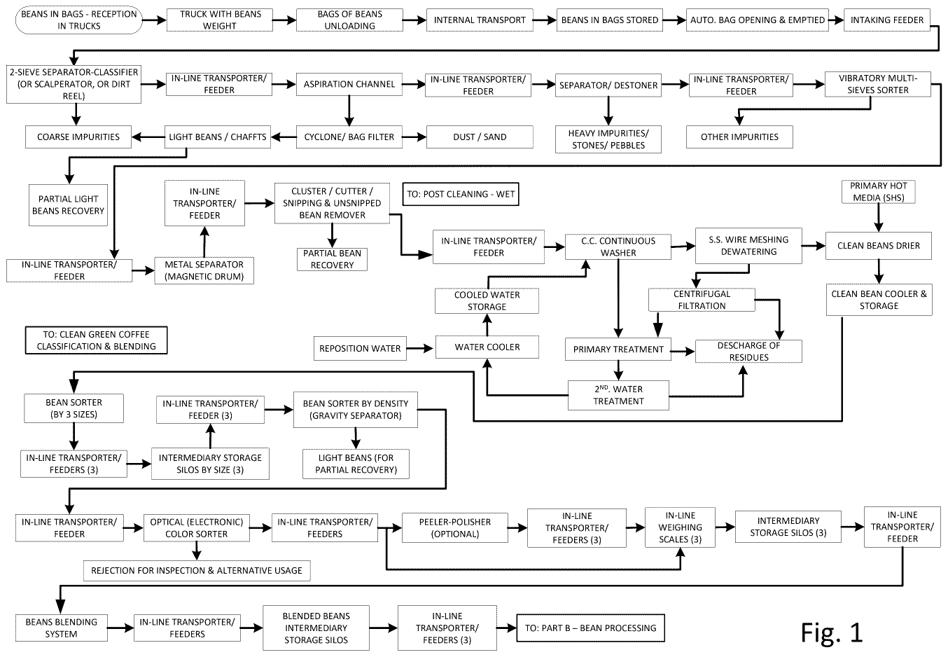

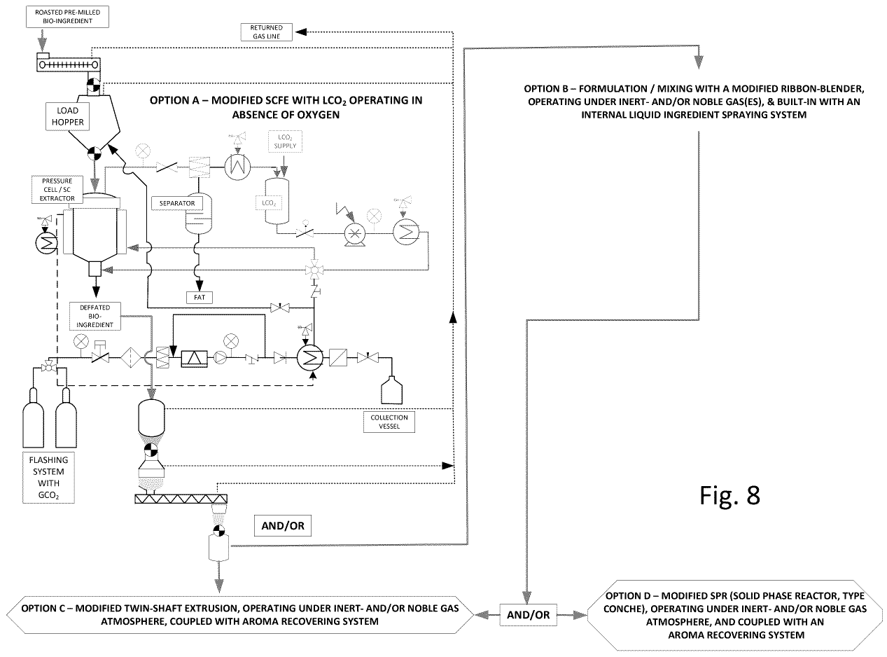

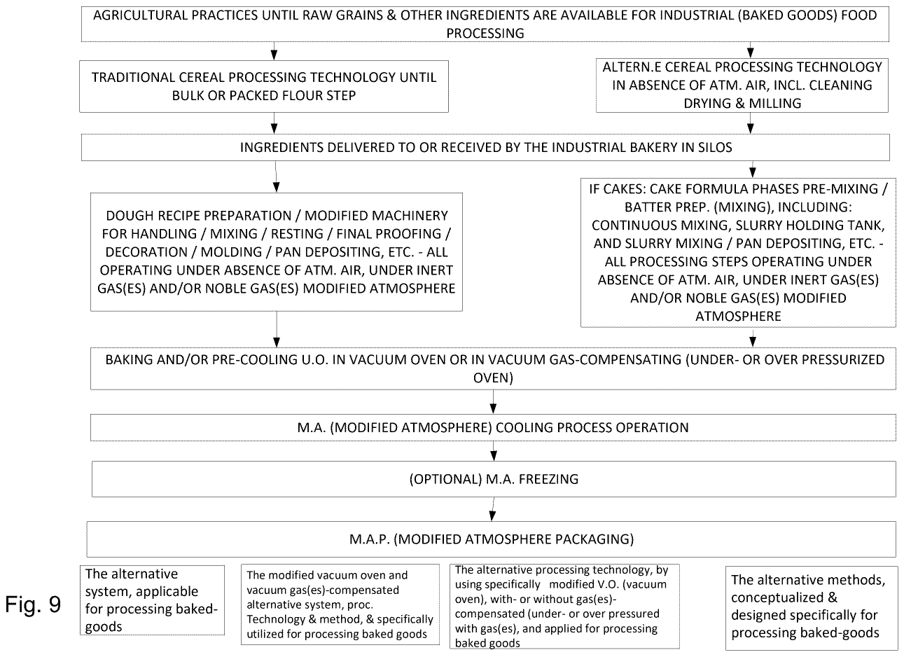

The subject matter of the present invention will now be described more fully with reference to the accompanying drawings (FIGS. 1 to 12)—as well as in their variants & options, in Tables 1, 2 and 3, which form part of this patent application's disclosure and illustrate specific exemplary embodiments. However, it should be understood that the subject matter may be embodied in various forms and is not limited to the specific embodiments set forth herein. Rather, these embodiments are provided by way of examples to convey the scope of the invention. It is intended that the claims encompass a broad range of subject matter, including alternative processing technologies, methods, devices, components, and systems. Accordingly, the following detailed description is not intended to be taken in a limiting sense.

As used herein, the term “exemplary” is intended to mean “serving as an example, instance, or illustration.” Any embodiment described as “exemplary” should not be construed as preferred or more advantageous over other embodiments. Similarly, the expression “embodiments of the present invention” does not imply that all embodiments must include all features, advantages, or modes of operation herein described.

The terminology used herein is for the purpose of describing particular embodiments only and is not intended to be limiting. As used herein, the singular forms “a,” “an,” and “the” include plural references unless the context clearly dictates otherwise. Furthermore, the terms “comprises,” “comprising,” “includes,” and/or “including” specify the presence of stated features, integers, steps, operations, elements, or components, but do not preclude the presence or addition of one or more other features, integers, steps, operations, elements, components, and/or groups thereof.

The following detailed description sets forth the best currently contemplated modes for carrying out exemplary embodiments of the invention. This description is not intended to be limiting, but rather to simply illustrate the general principles of the invention. The claims of any issued patent will define the scope of the invention.

The invention described pertains to proposed processing technologies and preparation methods for baked bio-ingredients and/or food products, in which atmospheric oxygen (air) is removed in one, or in all steps of the process. This way, the disclosed baking process for bio-ingredients and/or food products preserves nutrition, lipids, essential oils, and the like bio-components that, otherwise, are susceptible to oxidation in presence of atmospheric oxygen (of the air).

The rationale for this, herein disclosed, alternative processing technology and method is to ensure that all bio-ingredients' components,—as well as all their derivative processed foods, i.e., all of the so called “Baked Goods”,—all subjected to a high-temperature baking process, are not directly-(and negatively) impacted by the numerous and key aspects of the generalized degradative pathway of the thermal processing of foods-nor they are submitted to the initiation (by means of a catalytic phenomenon) of the chain of reactions,—also known as oxidative (and/or rancidification) processes of the fats, proteins, and the interaction with carbohydrates, aroma volatiles, and other chemical reactions, present or generated along the process,—all conducive to the resulting inexorable & irreversible degradation of quality & shortening of the products' shelf-lives,—besides preventing,—in a variable amount, the formation of harmful (for health) chemicals in the food products, whenever consumed.

Various unit-operations of the alternative processing technology for the preparation of the bio-ingredients, and/or foods may be modified to remove atmospheric oxygen (air) from within the unit operations. For example, the unit may be roaster, and the removing of atmospheric air will allow roasting in absence of atmospheric oxygen, thereby preventing oxidation, and/or formation of various potential harmful components or raw materials or semi-processed raw materials being used, in the preparation of the bio-ingredients and/or food products.

For removing the oxygen (air) from the unit-operations of alternative processing technology, various methods can be used, such as vacuuming, and/or replacing the air with inert- and/or noble gases. It may be noted that any type of food-compatible gas that may not affect or modify the bio-ingredients being processed may be used and any such gases are within the scope of the present process within this invention. For example, the inert gases that can be used include nitrogen (N₂), carbon-dioxide (CO₂), superheated steam (S.H.S.), and like food-compatible gases. The noble gases may include helium (He), neon (Ne), argon (Ar), and the like food-compatible gases. It is to be noted that a combination of gases may also be used without departing from the scope of the present invention. It is to be noted that the inert/noble gas(es) component or combinations thereof may also act and/or used as a heat transfer medium.

In certain implementations, the disclosed process includes packaging, wherein the prepared bio-ingredients or food products may be stored under vacuum- or inert/noble gas(es) atmosphere, and the corresponding utilization of a suitable or compatible packaging material for the specific process requirement, envisaging extended shelf-life of products.

In certain implementations, one or more steps of the process may be performed under vacuum-, normal compensated atmospheric pressure (i.e., under compensated pressure with the use of inert gases), or under inert- and/or noble gases' pressurized conditions.

In certain implementations, the alternative processing technology may include different unit-operations that are used simultaneously or consecutively for different steps in the preparation of bio-ingredients or food/beverage-derivative products. These units may be:
Special Roaster—The specifically designed roaster can operate in absence of oxygen (air). In one embodiment, the roaster allows for an inert/noble gas(es) to act as a heat transfer medium (a), which may,—or may not contain built-in quenching and/or “Torrefacto” capabilities.
Modified Two-Stage Fluid-Bed Dryer &/or Cooler (F.B.D.&/orC.): Apparatus built in two-stages, i.e., by adopting the specific concept, design and application, for operating in absence of oxygen (air), and equipped with Quenching and/or “Torrefacto” capabilities.
Modified & special Ribbon-Blender (S.R.B.): operates under absence of atmospheric air, and is equipped with spraying system for ingredients and additives, for optional blending, formulation, add-backs of recovered aromas.
Liquid carbon dioxide-based Super-Critical Fluid Extractor (LCO₂-S.C.F.E.): Modified due to the need to install both inlet- and outlet coupled apparatuses, to secure, respectively, the loading-in and load-out of the bio-ingredients and/or their food derivatives, under absence of atmospheric air.
Modified & special conche (S.C.), i.e., an apparatus built as a special solid-phase reactor (S.P.R.), enclosed, to operate under absence of atmospheric oxygen (air), under vacuum-, vacuum-compensated-, or pressurized operating conditions, and optionally, coupled with an aroma recovering system (A.R.S.), for further processing technology-added step.
Modified & special high-pressure extruder (S.H.P.E.) (mono or dual screw-types), built-in with both the inlet- and outlet enclosed, to operate under absence of atmospheric oxygen (air), and optionally coupled with an aroma recovering system (A.R.S.), for further processing technology-added step; and,
Modified Cryogenic Ball (C.B.M.), Jet (C.J.M.), or other types of (dry- or wet) mills, where there is a first processing step, (i.e. cryogenic coarse milling) and, as second step, the cryogenic ultrafine-milling, using these equipment &/or devices, equipped with their inlet- and outlet enclosed, to operate under absence of atmospheric oxygen (air),—respectively, for pre-milling and ultra-milling of coffee, cocoa, chocolate, edible nuts, and the like, and/or of the bio-ingredients and/or herbs & leaves, such as teas, matte, and variants of the drinkable bio-ingredients. This, in order to reach the following processing results:
   Pre-Milling (1^{st} step): between 75 and 500 microns of average particle size; and
   Ultra-fine Milling (2^{nd} Step): from <0.1 microns (less than), to a maximum of 25 microns, using cryogenic dry- or wet milling as the preferable method for improving dispersibility of insoluble particles from these bio-ingredients and/or finished food products.

The novel and special roaster (S.R.) was conceptualized for operating under vacuum-, vacuum-compensated-, or pressured (in the latter case, through means of compressing inert/noble gases, alone or in combination) for processing bio-ingredients and/or food products. According to certain embodiments of the present invention, the referred equipment is, essentially, a box-type enclosure, equipped with means to remove oxygen (air) from within the enclosure, thus creating a vacuum,—or vacuum-compensated,—or pressurized (in both latter cases, using inert/noble gas(es),—alone or in combination) in the enclosed environment. Various construction materials can be used to manufacture the roaster apparatus, such as various metals,—provided they are recommended for use in food processing equipment, and suitable to operate under negative, or positive pressure conditions (or under a vacuum, atmospheric-compensated,—or pressurized environment), and capable of withstanding at all temperatures required for safe operation of the roaster. The special roaster can be designed in form of cabinet-(or batch type), or continuous processing type. The special roaster may include suitable heating mechanisms, such as Direct- or Indirect-Fired: gas, liquid or solid (mono- or dual fueled),—however only with indirect contact with the bio-ingredients being processed; Electric: generally indirect (natural and/or forced convection and/or radiation), by heating the gas medium (e.g. air); however, in such a case, only in indirect contact with the bio-ingredients being processed; Microwave (IR) & RF; or any other suitable heating-transfer mechanism known to a skilled person for use in bench/commercial/industrial roasters or ovens.

In certain implementations, the entire process, from the receiving of the raw materials to the packaged & stored finished product, may be conducted in absence of atmospheric oxygen (air).

In certain implementations, in preparing the bio-ingredients, and/or composite food masses, the baking process may be carried out in a modified & special Vacuum Oven (S.V.O.) and/or Vacuum-Compensated (S.C.V.O.), with Inert- and/or noble gas(es)—while operating at N.A.P.E. (Natural Atmospheric Pressure Equivalent), sub- or super-pressurized conditions' Oven (S.P.O.),—all of them modified and specials, which were conceptualized, and/or adapted specifically for the food-related applications herein disclosed.

In certain implementations, one or more processes in the preparation of the bio-ingredients, in addition to the roasting, may be performed in vacuum,—vacuum-compensated & under or pressurized inert/noble gas(es) environment, wherein the one or more units for the disclosed processing technologies, in addition to the roaster, may facilitate creation of vacuum, or replacing the oxygen (air), under-, even- or over pressurized with the inert/noble gas(es). Also, in a continuous process, wherein raw materials are being processed in stages, the transfer of the raw materials, from one unit to another, may also be conducted under vacuum/inert gas(es) atmosphere. It is to be noted that various unit-operations in the alternative processing technologies may be used inter-connected to each other, wherein the inert atmosphere or vacuum is maintained throughout the sequence of unit-operations required for the entire process.

In certain implementations, the disclosed alternative processing technology chiefly includes roasting, baking and milling units in which the critical processing of unit-operations are performed in vacuum- or inert/noble gas(es) atmosphere.

In certain preferred embodiments, disclosed are alternative processing technology and method for avoiding the oxidation of the bio-ingredients in all stages of the processing steps, applicable to the specific bio-ingredients and their derivatives, thus preventing at all times the direct contact of oxygen (air) with the bio-ingredients being processed in all the processing steps. For the same motive, applicable individually to every unit-operation preconized by this patent application,—specifically during the following processing steps: (1) In all phases of the Pre-conditioning of the specific bio-ingredients; (2) In all the intermediate storage & transportation steps of the entire process; (3) In the mandatory roasting or baking processes, which are applicable to all the specific bio-ingredients and/or their drinkable derivatives; (4) In the Modified Fluid-Bed Drying &/or Cooling (Single- or Dual Steps), equipped with “Torrefacto” and/or Quenching Devices; (5) In the (optional) liquid carbon dioxide-based Supercritical Fluid Extraction of the residual fats; (6) In the (optional) Ribbon Blending/mixing/formulating and equipped with a spraying system; (7) In the (optional) special conching and/or in the special high-pressure extruding,—both processes operating in the absence of atmospheric oxygen (air), and (8) (optionally) equipped with an Aroma Recover System, and apparatuses: (1) steam consisting of 2 stripping/distillation/fractionation+(2) cryogenic condensing unit, employed for recovering the bio-ingredients and/or food masses' aroma volatiles under processing, by using cryogenic technology, and for later on (and optionally), being added-back to the finished products at specific step(s) of their processes. This could be done in selected steps of the process, but preferably, during the agglomeration, micro-encapsulation and/or instantizing/coating of the particles-all of them conducted under the absence of atmospheric oxygen (air), and in the presence of inert/noble gas(es). In both Pre-milling and the Ultra-fine milling processes, the use of cryogenic technique, is to prevent (1) over-heating; and/or (2) loss of aromas; and/or oxidation by excluding atmospheric oxygen (air) during the processes. In the packaging of the bio-ingredients and their food- and/or drinkable derivatives, the use of inert/noble gas(es) provided a direct beneficial effect in their extension of the shelf-life of the products, based on the storage in absence of atmospheric oxygen (air) until their final consumption as food and/or drink.

In certain implementations, also disclosed is a two-stage Fluid-Bed Drying and/or Cooling (F.B.D.&/orC.)—operating in absence of and equipped with a ‘torrefactor’ and/or quenching devices' capabilities.

In certain embodiments, disclosed are an alternative processing technology and method for preparing bio-ingredients and/or food products, the process encompassing: (0) the various initial- or intermediary storages of the bio-ingredients being processed (such as silos, tanks, etc.) under various phases (or steps) of their processing, (1) roasting of bio-ingredients; (2) pre-cooling, (3) cooling, and/or quenching, (4) (optional) “torrefacto”; (5) the pre-milling & ultra-milling, carried out under cryogenic conditions; (6) (optional) mixing/formulating using a modified & special ribbon-blending of ingredients; (7) (optional, done under modified equipment conditions) LCO₂-based super-critical fluid extraction, to ensure absence of atmospheric oxygen (air)—especially in the load of the bio-ingredients and unload of the de-fatted processed bio-ingredients; and (8) the various (optional) processing alternatives, in modified processes, herein disclosed, such as (9) agglomeration, or (10) microencapsulation, (11) coating and/or instantization, and the optional (12) adding-back of ingredients and/or additives.

In certain implementations, the disclosed alternative processing technology and method may optionally include a special solid phase reactor apparatus, such as the modified & special conching (S.C.), or special high-pressure extrusion (S.H.P.E.),—having any of these equipment (optionally) attached to an Aroma Recovery System (A.R.S.), and consisting of (1) one steam/S.H.S. volatiles stripping/distillation/fractionation column (S.D&F.C.); and (2) one cryogenic condenser unit (C.C.U.)—their respective processing technologies and features.

In all pertaining embodiments, the following: (1) specific utilization of vacuum, and/or atmosphere-compensated options, with the use of inert gas(es), such as: Nitrogen (N₂), Superheated Steam (S.H.S.), and the like; and/or of noble gases, such as: Helium (He), Neon (Ne), Argon (Ar), and the like,—whist these variants having as commonly mandatory requisite the proposed application of the Novel/Modified/Special Equipment (or Machinery); and (2) that the disclosed processing technology were only applicable for baking- or roasting-based bio-Ingredients, and/or foods and/or beverage products, herein disclosed throughout the patent application document.

Examples of baked products that can be manufactured by the disclosed process includes, but not limited to: Breads, Buns & Breadsticks, Buns/(Hard) Bread Rolls, Cakes, Pizzas & Calzones, Cereals/Breakfast Cereals, Pies (Salted, Savory and Sweet), Torte & Tarts, Bagels, Ready Meals, Snacks (Salted, Savory and Sweet), Muffins, Viennoiserie (Croissants, Brioche, Puff-Pastries), Baked Doughnuts, Baked Chips, Pretzels, Biscuits: Cookies & Crackers, Pastries (Salted, Savory and Sweet), Crispy Breads, Granolas & Mueslis, Flatbreads, Pita Breads, Macaroons, Twice-baked Foods, and Other Baked-Goods (e.g., empanadas). The invention may be extended to encompass all baked-based ingredients and products, fundamentally preventing and/or protecting their delicate, heat- and/or Oxygen-sensitive bio-ingredients for imparting immediate and/or long term deleterious chemical, physical, physic-chemical, safety, nutritional and/or rheological changes in those ingredient or products, thus compromising quality, health safety, shelf-life, sensorial (such as organoleptic) and/or nutritional properties of these bio-ingredients under basic consideration.

For instance, bio-ingredients processed according to the described systems, alternative processing technology and methods generally exhibit shelf lives greater than one year, even in open or unopened containers, and under various storage conditions. If fact, they generally exhibited shelf lives greater than one (1) year, and up to five (5) years,—even in opened or unopened containers,—depending on the specific bio-ingredients, the adopted alternative processing technology, and the various alternative storing conditions. Thus, the resultant bio-ingredients and/or the corresponding food products, if processed accordingly to the disclosed art, are transformed into high-quality end-products, and importantly, exhibiting extended shelf lives, when compared with traditional or commercially available processing alternatives.

It was found that the disclosed process, technology & method thereof significantly improved the shelf-life of bio-ingredients, compared to when prepared using traditional methods. For example, roasted and ground (R&G) coffee,—depending on the type and nature of the package, and if prepared by traditional methods has a shelf life typically varying from 1-9 months. This is because when the bio-ingredient is processed at high temperatures in the presence of heated atmospheric oxygen (air), it undergoes significant oxidation process, which is aggravated when subjected to further stages of processing, such as cooling and milling. In contrast, when the same R&G coffee is prepared using the disclosed process, it showed the shelf life of up to one year, even if is stored in opened container; however,—in case of package conducted under vacuum- or atmosphere-compensated inert/noble gas(es), and, also depending on the type and nature of the package,—as well as under various storage conditions, the shelf-life can be extended up to five (5) years.

In certain implementations, the stability and shelf-life of the bio-ingredients may also be substantially increased by employing additional techniques, such as agglomeration, micro-encapsulation, instantization, or coating the bio-ingredients with food-grade additives such as dispersants, emulsifiers, antioxidants, and other suitable agents,—provided that these unit-operations are conducted in the absence of atmospheric oxygen (air). By using these systems and methods herein disclosed, they may facilitate the end-products' wettability, water-solubility, and overall dispersion ability, as well as other physical, chemical, and rheological attributes.

In particular embodiments, bio-ingredients processed in accordance with this disclosure present an approximate average size for final milled roasted cocoa or coffee particles (or any other milled bio-ingredients, discussed herein) may range from no greater than 25 microns, to as low as <0.1 microns (less than) for the ultra-fined particles processed under cryogenic conditions, and can be further processed to yield agglomerates or coated particles, suitable for better commercial presentation/application.

Hence, enhanced dispersion and stabilization of bio-ingredients may be achieved by agglomeration, microencapsulation, coating or instantization of the bio-ingredients, with- or without the utilization of suitable food-grade additives (e.g., dispersants, emulsifiers, antioxidants, and other suitable agents).

In particular embodiments, the systems, alternative processing technology and methods disclosed herein facilitate the end-products' wettability, water-solubility, and/or overall dispersion ability (as well as other physical, chemical and/or rheological features) and/or oil-based, such as in the case of chocolate powders' preparations.

In certain embodiments, complementary, additional and/or optional processing technologies may be included in the disclosed systems, processes and methods, such as the add-in of micro-encapsulated of ultra-fine powder or, alternatively, the agglomeration and subsequent coating of the granules, to uniquely allow the powdered version's finished product to satisfy many of the above-mentioned properties and features, while also ensuring that the particles of the end-products are completely protected against oxidation.

In certain implementation, the disclosed process may also include packaging of the bio-ingredients and food products. The final packaging under vacuum, or atmosphere-compensated with inert/noble gas(es) may further extend the composition's shelf life. The systems, processing, equipment, and methods discussed herein provide tangible extra benefits, such as significant shelf-life extensions, enhanced convenience of preparation, improved yield extension, and extended storage and utilization,—with some of the final products becoming well-stable, even without the use of chemical preservatives and/or refrigeration.

In certain embodiments, the disclosed process may also include the extraction steps of essential ingredients, such as aroma recovery from the raw materials or semi-processed-raw materials which are being- or to being used to prepare the bio-ingredients and their derivative-food products. These essential ingredients may be preserved while the materials are processed. These essential ingredients (e.g. aromas) can then be incorporated at the final stages to prepare the bio-ingredients, and their derivative food products i.e., through means of “adding-back” process alternatives,—thus retaining their fresh natural aroma and nutritional value. For instance, roasted coffee, cocoa, their chocolate derivatives, edible nuts, tea and similar drinkable herbs all exhibit volatile and non-volatile aroma components,—some of them further developed while submitted to the special roasting process.

In the specific case of the whole roasted coffee, there is around 11 to 15% of the bean content in coffee's essential oils, which could be processed through pre-extraction and stored, & preserved under cryogenic conditions, until the finished product is ready to be eventually added-back to the coffee's processed bio-ingredient, or to the whole or partial coffee-based mass' products, just before the full process is completed, after inert-gas, closed-loop modified spray-drying or freeze-drying operations, (i.e., during micro-encapsulating, agglomerating or instantizing/coating phase),—but ideally, before final (primary) packaging is completed.

In particular embodiments, the alternative processing technologies herein disclosed optionally include a modified liquid carbon dioxide-based supercritical fluid extraction (LCO₂-S.C.F.E.), which is a process for selective extraction of essential and/or oils from bio-ingredients (such as coffee oil from coffee beans). However, the standard apparatus employed must be especially modified by equipping it with fully enclosed inlet- and outlet apparatuses, operating under a gas-locked system, and especially designed to prevent the entrance of atmospheric oxygen (air), and under either vacuum, or partial- or total atmosphere-compensation with the use of inert/noble gas(es).

According to various aspects of the present disclosure, extracted fluids may include essential oils and/or polyunsaturated fatty acids (P.U.F.A.)—food oils, which are prone to oxidation; thus, pre-removing essential oils and/or PUFA.s reduce the risk of the bio-ingredients becoming oxidized during the roasting and milling processes, and allow for greater shelf-lives of the bio-ingredients. In various embodiments, the cryogenically removed/recovered essential oils and/or PUFA.s may be added-back into the roasted and milled (i.e., processed) bio-ingredients, if so desired, so to improve their final aromas and/or tastes.

Aspects of the present disclosure aim to provide, in the specific case of edible liquor, mass, emulsions or similar dry- or wet milled bio-ingredients and food products, those that efficiently retain the volatile and non-volatile chemicals and flavors components of bio-ingredients during roasting and milling, therefore allowing the consumer to enjoy a whole, fresh, natural, and agreeable roasted food and/or beverage organoleptic experience, presented as final processed food products in liquid, paste, emulsion, and in solid forms.

The detailed descriptions included below and elsewhere throughout this patent application, refer to embodiments depicted in the accompanying drawings and should be considered in accordance with their disclosures.

### FIG. 1—Pre-Processing (Initial Steps):

### Incoming of the Selected Bio-Ingredients: (e.g., Beans, Nuts, or Other Bio-Ingredients).

In various embodiments, green coffee, edible nuts, cocoa beans, or the like, are initially received under commercial (exporting) Phyto-sanitary/quality conditions, in bulk or bags. In certain embodiments, the product is checked for weight and residual moisture, as for quality classification. In response to accepting the product, it may be stored for later processing.

In certain embodiments, as applicable for tea and/or similar drinkable herbs, both the dry- and wet cleaning processes may be adapted to accommodate the physical & chemical conditions of the dried leaves, and specialized commercial equipment may be used to ensure their complete cleaning and removal of solid impurities, before the liquor (or mass) manufacturing process stage takes place. The manufacturing process may then follow the same sequence of unit-operations as described for the other bio-ingredients under consideration, i.e., entirely under absence of atmospheric oxygen (air).

### Dry Pre-Cleaning:

In various embodiments, processing (e.g. beans) generally includes opening and emptying bags and moving through a sequence of unit-operations, with the aim of further eliminating impurities present in the bags or bulk loads. Examples of various equipment and the impurities they may remove are included below, in case of beans:
Two-sieve separator & classifier (also referred to as “Scalpelator” or “Dirt Wheel”), to eventually eliminate coarse impurities.
Aspiration channel, to eliminate light beans and chaffs.
Separator & de-stoner, to eliminate eventual heavy impurities, stones and/or pebbles.
Vibratory, multi-sieves sorter, to eliminate other small impurities.
Magnetic separator, to separate metal contamination.
Cluster, Cutter, Snipper & Un-snipped bean remover, to separate defective beans.

### Wet Cleaning:

In various embodiments, the pre-cleaned and dried beans are subsequently submitted to a series of additional unit-operations, collectively part of the entire wet-cleaning process. As will be understood by one of ordinary skills in the art, conventional methods for cleaning bio-ingredients, such as commercial graded green coffee beans, typically rely only on dry cleaning (e.g., sifting, air-blowing, etc.).

According to various aspects of the present disclosure, adding wet-cleaning steps of the bio-ingredients,—although adding processing costs,—nevertheless it significantly improves cleanliness by removing impurities, which are typically, not efficiently removed by dry-cleaning methods; this allows for the entirety of the bio-ingredients (e.g., the whole coffee bean) to be utilized as a direct consumable product. Wet cleaning may include the following sequence of operations:

Continuous cool water washer, to prevent excess water absorption by the beans (with- or without the use of a food-grade approved active surface agent and/or disinfectant, with the aim to facilitate the cleaning & sanitation process), where the rejected primary cleaning water may be sent to the primary water treatment, and subsequently to the secondary treatment, before it may be returned to the process; and

Wire mesh (vibratory) de-waterer, where further water recovery is achieved, and continuously returned to the water primary treatment. In various embodiments, the wire mesh may be adaptable (e.g., change mesh/screen sizes) to accommodate various types of bio-ingredients.

### Special Drying:

According to various aspects of the present disclosure, the green beans, with an average residual moisture of around 25 to 40%, are then transferred to the bean-drier, including a 2-stage vibratory S.S. mesh-type fluid-bed chambers, where:

In the first chamber (dryer's 1^{st}. stage), and in various embodiments, there is upwards continuous injection of controlled volume and temperature of moderately hot, HEPA-type pre-filtered sanitary air, and at the top portion of the chamber's humid air is forcefully extracted and passed through a cyclone arrangement to recover any solid particulates.

The dried hot green beans enter the second (2^{nd}.) Fluid-bed stage (i.e. the cooling stage), where cool (HEPA-type pre-filtered) sanitary air is continuously injected upwards into the fluid bed (whereas the pre-heated air exists through the top of the bed through forced extraction and, subsequently, passing through a cyclone configuration, to collect eventual solid particulates); Then, the finished beans, with an average residual moisture of 7-8.5%, are then subsequently transported and stored in metallic silos (for wet clean & dry green beans).

### Physical Classification & Selection:

In particular embodiments, the wet-cleaned and dried green beans are then submitted to the classification and selection processes. According to various aspects of the present disclosure, this classification and selection process improves the overall quality of the final roasted bean product, by ensuring an even- and consistent roasting, whereas simultaneous roasting of different sizes and shapes of the “green” (or crude) cleaned beans, if done altogether, might produce inconsistent and irregular roasting. The classification and selection processes may include the following sequence of unit operations:
Bean sorter by size, to classify the beans into at least 3 sizes/shapes, i.e., small, medium and large beans,—thus reducing the amplitude of bean size and shape's variations, and whose sizes/apertures and/or types should be specifically selected for the type and commercial classification of bio-ingredient being processed.
During the roasting process of the wet-cleaned & dried green beans, each of the these three size (or fractions) categories are conducted separately. This technique minimizes both the under-roasting and the over-roasting of beans during the special roasting unit operation's next processing step, by approximately pre-standardizing the shapes and sizes (and therefore the surface areas of the individual beans).
Bean sorter (gravity separator), to eliminate light, perforated beans for partial subsequent recovery.
Optical (electronic) color sorter, to ensure homogeneity of the beans through color, which indirectly affects the (future) roasted quality of the processed beans.
(Optional) Peeler-polisher, to provide a better bean presentation of the lot; and
Blender of distinct types (origins) of the green beans, according to the recipes, while respecting the individual processing of three pre-defined bean average sizes.

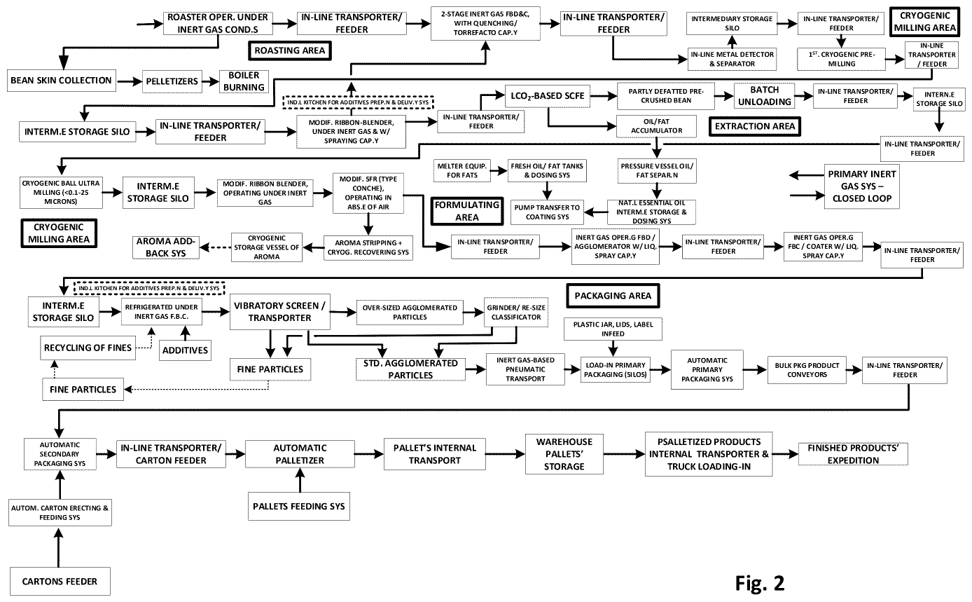

FIG. 2—BIO-INGREDIENTS PROCESSING (FINAL PROCESSING STEPS)—Sequential Processing: The Block Flow Diagram (B.F.D.) presented as FIG. 2 indicates all the recommended processing steps for the bio-ingredient(s) being processed, once they are properly pre-processed, according to the information disclosed in the FIG. 1 above. Note that all processing operations, from this 2^{nd}. phase on, (i.e., starting with the stored, homogeneous lots of each of the 3 sizes of the wet-cleaned, dried, and blended types of beans), the sequential processing operations are to be conducted in the absence of atmospheric oxygen (air), in order to preserve the integrity, flavor, shelf-life and health security of the bio-ingredients.

Once roasted-processed in the special roaster, the roasted beans are bulk-stored in intermediary silos, under absence of atmospheric oxygen (air), while waits for additional processing, through a sequence of processing steps, and previously described, as follows (SEQUENTIAL STEPS OF FIG. 1)—BRIEF LISTING: With all processing steps carried out in the absence of atmospheric oxygen (air) (Continuation):
Intermediate Store/Feeding Silo of Roasted Beans.
(Optional) Metal Detection & Removal.
Cryogenic Pre-Milling (C.B.M.-1) at 75-500 microns.
Intermediary Silo for storage of the pre-milled & roasted ingredient.
Cryogenic Ball Ultra-Milling (C.B.M.-2) to reach <0.1 to 25 microns.
Intermediary Silo for storage of the Ultra-Fine-Milled roasted ingredient.
Optional Processing Steps:
   Modified & special ribbon blender (S.R.B.) for optional Formulation.
   Modified solid fluid-bed Drying &/or Cooling (F.B.D.&/orC.) for drying & cooling.
   Modified solid-phase reactor (S.P.R.) (such as the special high-pressure extruder (S.H.P.E.) or special conche (S.C.), w/or w/o-an optional aroma recovery system (A.R.S.) set of two (2) apparatuses.
(Optional) Aroma recovery system (A.R.S.), consisting of: (1) a special steam stripping/Distilling/Fractionating column (S.D&F.C.)+(2) cryogenic condensing unit (C.C.U.) apparatuses.
Ultra-fine Powder Post-Processing, envisaging extension of shelf-life, better physical, physical-chemical and/or rheological properties for its use (such as dispersibility, etc.), by means of:
   Modified Fluid-Bed Drier &/or Cooler (F.B.D.&/orC.), type “Agglomerator”, equipped with liquid (aromas, and/or additives) spraying capability—for particle drying/agglomeration, or the use of a fluid-bed drier type “coater”,—also with liquid spray capability, and operating under vacuum, partial- or total-atmosphere-compensated inert/noble gas(es); or
   Modified two-stage Fluid-Bed Cooler, operating under vacuum, partial- or total-atmosphere-compensated inert/noble gas(es);
   Particles' micro-encapsulation, carried out in similar (F.B.D.&/orC.), w/or w/o food-grade additives; or
   Micro-particles Instantizer/Coating, carried out in similar (F.B.D.&/orC.), w/or w/o food grade-aromas and/or additives.
Classificatory by particle size, enclosed & special vibratory screen (S.V.S.)—Separation by size in standard- and over-sized particles, for product differentiation or proportional adding-back, and operating under atmosphere-compensated inert/noble gas(es).
Intermediary special storage silo, or special Tote Bins, with enclosed screw-conveyor for load-in, done in absence of atmospheric air, and silo operating under atmosphere-compensated inert/noble gas(es), whose product generally is transported forward (load-out to the primary packaging silo), through a special, enclosed, inert/noble gas-based pneumatic transporter.
Primary Packaging (in various types, under absence of atmospheric oxygen (air).
Secondary Packaging (such as Cartooning).
Palletization; and
Warehouse storage.
QA Release & finished product expedition.

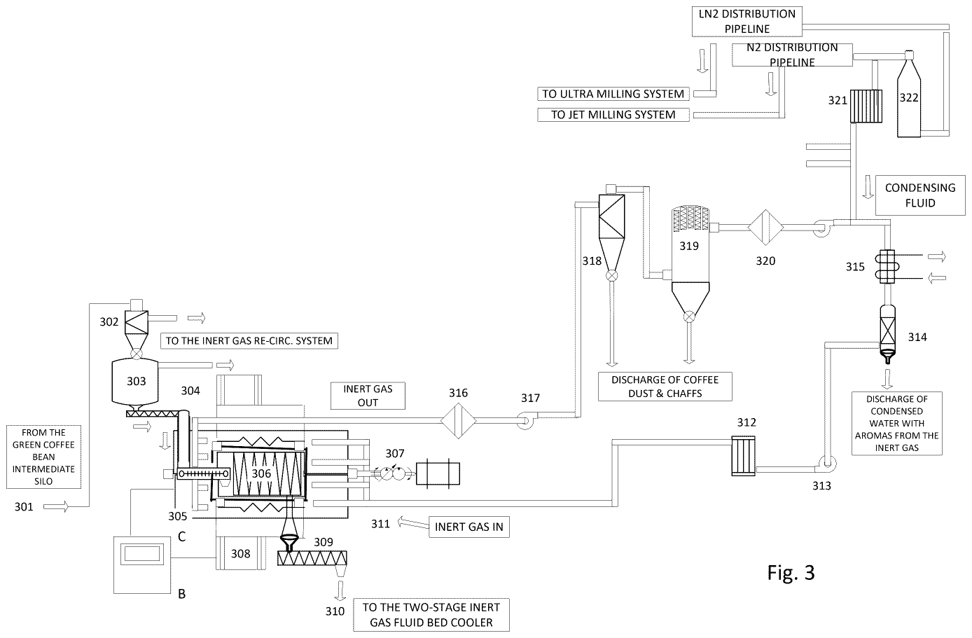

Referring to FIG. 3, it illustrates one type of the modified & special roasting concept, process & equipment. The special roasting is conducted by means of a new concept of equipment: hermetic, & in all variations, operating in absence of atmospheric oxygen (air) (i.e., to prevent atmospheric oxygen (air) intake, and heated by means of: direct- or indirect fuel burning (gas, liquid or solid)—in such cases allowing only indirect contact of combustion gases with the bio-ingredients being processed), and/or by indirect- or direct heating using Super-Heated Steam (S.H.S.) and/or by any suitable inert and/or noble heated gas(es), such as: Nitrogen (N₂), carbon dioxide (CO₂), Helium (He), Neon (Ne), Argon (Ar), and the like, equipped with built-in inert/noble gas(es) used in the processing/internal environment recovering system, and/or by means of electricity and/or by non-ionizing electromagnetic waves (IR or RF) of a defined wavelength spectrum,—also having the heat source,—either built-in the main apparatus or externally to it.

FIG. 3 shows the process where the green coffee beans, after their dry, wet cleaning & final drying, and classification, can be then stored, and, from there,—all the steps of the process forward, starting with the special roasting, are conducted under inert/noble inner atmosphere conditions. Thus, the pre-processed cleaned & dried green coffee beans, after classified, and blended can be initially subjected to special roasting, under inert gas conditions as illustrated. FIG. 3 also shows an example of electric heating system, where it illustrates: clean & dried, classified & blended green coffee loading 301, discharge cyclone 302, load intermediary storage 303, screw feeding system 304, coffee roaster under inert gas 305, rotary roasting drum 306, electric motor w/rotation control 307, electric heater & source 308, roasted coffee discharge device 309, discharge of the roasted beans 310, inert gas distribution pipeline 311, inert gas heat exchanger 312, inert gas fan 313, coalescent condenser 314, moisture condenser 315, HEPA filter 316, exhauster fan 317, cyclone 318, bag filter 319, HEPA filter 320, inert gas heat exchanger 321, and inert gas primary storage tank 322.

According to various aspects of the present disclosure, the systems discussed herein include a new concept, unique, and potentially-feasible & commercial, novel equipment that allows the special roasting of the list bio-ingredients disclosed, done under absence of atmospheric oxygen (air), thus avoiding oxygen in direct contact with the bio-ingredient(s) being processed.

In various embodiments, special variants of the novel roaster may be manufactured for batch- or continuous-type operations, manual- or automatic, in various capacities, from 0.1 Kg (Lab/Bench scale) to 20,000 Kg/Batch or “per Run” (i.e., continuous, and considered to be largest (practical) industrial-scale size).

In particular embodiments, these proposed novel-concept special Roasters variants are to be fabricated to be load-in in absence of air and to operate full cycle air-sealed, using for their design & assembly made with any metal allowed for this type of unit-operation (i.e., special roasting) and, in case of using any suitable inert/noble gas(es), to be built in a closed- or semi-closed-loop configuration i.e., coupled with a recovering gas device, in order to minimize gas losses to the atmosphere.

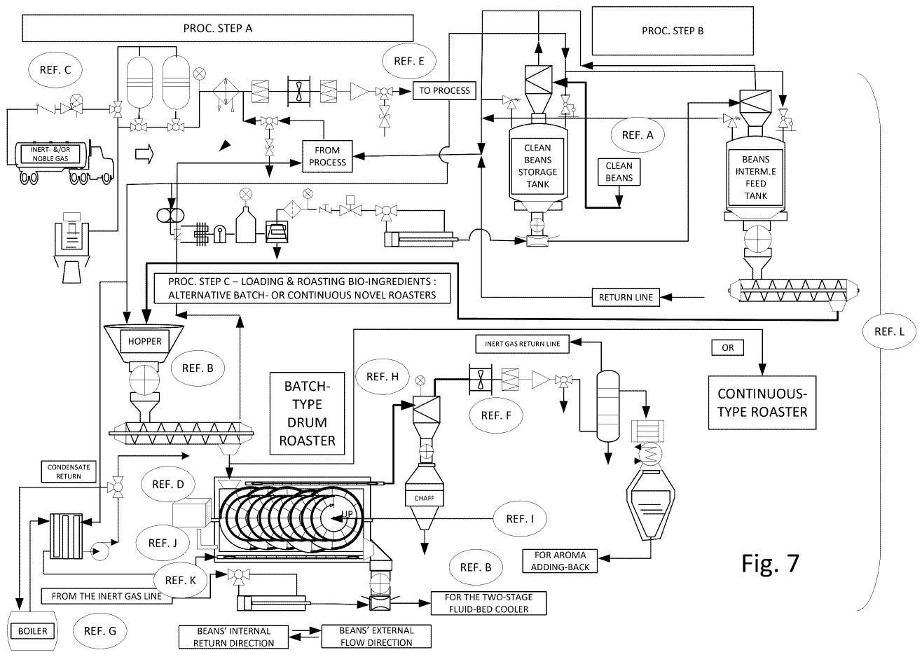

Variations of the illustrated special Roaster (also under FIGS. 3 and 7) may operate from medium to high vacuum (e.g. 0.001 Torr), to moderate vacuum (e.g. 25 Torr), to low vacuum (<760 Torr), with or without partial- or total vacuum compensation by means of utilizing any suitable inert gas (such as S.H.S.), and/or noble gases (such as Helium—He), and, in such cases, equipped with a built-in gas(es) recovering system, also utilized as heating source or medium. Moreover, the following table presents a summary about the suitable sources of heat, which may be utilized, alone or combined (i.e., as hybrid sources), as required and/or applicable for the novel & special roaster and oven apparatuses (and their conceptual design variations). They were also presented in more details, in FIG. 3, and FIG. 7,—as well as in Table 1, Table 2, and Table 3, herein disclosed, illustrating further the several already described features, for the concept, design, construction and operation of both the novel special roaster and oven,—respectively in form of simplified basic design and block flow diagrams, their lists of variants, and all sources of heating that may be applied, as informed by the inventor.

In particular embodiments, the heat media can also be in direct (or indirect) contact with the bio-ingredients, except in case of burned fuels, where it will be mandatory to be only in indirect contact with the bio-ingredients being thermally processed.

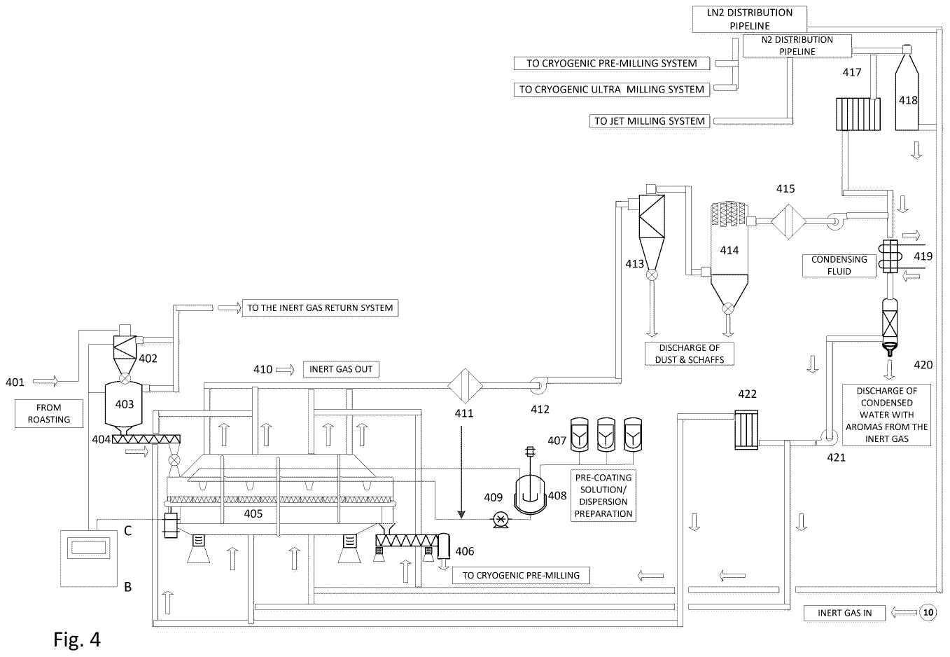

Referring to FIG. 4 which illustrates the quenching & optional “torrefacto” (built-in) processing. It illustrates roasted coffee obtained in FIGS. 1 and 2, being cooled in 2 stages, with optional possibility of quenting and/or coating (“torrefacto”) the coffee beans. FIG. 4 simplified block flow diagram (B.F.D.) illustrates: roasted coffee loading 401, discharge cyclone 402, load intermediary storage 403, screw feeding system 404, two-stage inert gas cooler with pre-coating application system 405, roasted coffee discharge screw 406, food ingredients/additives tanks 407, enclosed coating boiler 408, positive displacement dosing pump for the nozzle sprays 409, inner gas pipeline network 410, HEPA line filter 411, inert gas exhaust fan 412, separation cyclone 413, filter bag tank 414, HEPA line filter 415, HEPA line filter 416, inert gas heat exchanger 417, inert gas primary tank 418, condenser 419, coalescent filter & condenser 420, inert gas blow fan 421, inert gas secondary heat exchanger 422.

### (Steps Continuation of FIG. 1)—Details

Thermolysis Quenching and Optional “Torrefacto” systems, immediately post-roasting, carried out in the absence of atmospheric oxygen (air).

In one embodiment, Drawing 4 depicts a spraying apparatus integrated with the two stage closed- or semi-closed loop Fluid-Bed Drier &/or Cooler (F.B.D.&/orC.), operating under inert/noble gas(es) conditions, which allows for the operator to incorporate a variable amount of water, sugars and/or sweeteners solution to the hot beans directly exiting from the special roaster, with the goal of quenching the thermolysis' reaction underway, (hence removing it through latent heat of condensation, and therefore interrupting (or quenching) the thermolysis' heating effect imparted to the roasted bean).

In certain embodiments, the spraying apparatus may also incorporate variable amounts of sweeteners at the surface of the roasted beans, which may create various tastes and special flavoring to the bio-ingredients under processing, besides further protecting the roasted beans for gas and/or air exposure.

In embodiments where the “torrefacto” process in not performed, the spraying effect can be utilized simply by using any cooling medium (ideally pure cool water), to simply quench the thermolysis reaction of the beans, down to a safe temperature level for the complete interruption of thermolysis.

In various embodiments, and if operating for quenching purposes, the system may, for example, deliver finely spread cool water through a spray nozzle (single- or double fluid stream), and be calibrated under the following processing conditions:
Water temperature: +0.1° C. to +90° C. (plus)
Water spraying timing: 1 to 20 minutes

In embodiments implementing “torrefacto-type” processing, the system may deliver finely spread cool water through a spray nozzle, and calibrated under the following processing conditions:
Sugar (and/or other food-grade ingredient or additive) solution's concentration: 1% to 60%.
Sugar (and/or other food-grade ingredient or additive) solution's temperature: +0.1° C. to +90° C. (plus).
Sugar (and/or other food-grade ingredient or additive) solution spraying timing: 1 to 20 minutes.
   Special 2-Stage Fluid Bed Pre-Drying &/or Cooling (F.B.P-D.&/orC.), Done in Absence of Atmospheric Oxygen (Air) (Also Illustrated in FIG. 4).

In particular embodiments, this step of the process utilizes a two-stage Fluid-Bed Drying (if required) & Cooling, while transporting and further cooling the roasted bean. In one embodiment, a closed-loop inert gas customized two-stage Fluid Bed Cooler, similar in part to the standard cooler model of the Food and Pharma Line, manufactured by Witte, 507 Rt. 31 S. Washington, NJ 07882, however operating in absence of atmospheric air and/or under inert gas(es) environment.

In various embodiments, the roasted beans are cooled down in the first stage to a temperature between 50° C. and 100° C., but preferably between 65° C. and 75° C. for at least one minute,—this is the primary goal to quench the thermolysis process of the hot roasted bean. In certain embodiments, and in the second stage, the temperature may be brought down to ambient temperature, also under inert gas conditions.

According to various aspects of the present disclosure, the roasted beans may be kept at this temperature for approximately five minutes (or another appropriate amount of time, such as from one (1) to over thirty (30) minutes); this to facilitate the initiation of the degassing process on the roasted bean (for instance, in the specific case of coffee beans). This process is normally completed (within one day) in the storage silos, before the product is packaged.

In one embodiment, also in the case of coffee beans as example, the beans may remain in the second stage indefinitely, since they would be stable at that phase,—provided that the inert atmosphere is maintained.

In particular embodiments, both cooling stages may be performed under an inert gas environment, by receiving a pressurized blow of cooled inert gas together with the mechanical vibratory screen to transport the beans forward. As should be understood by the discussion herein, the procedures described are executed in the absence of atmospheric oxygen.

In a particular embodiment, the preconized system may be modified to include an upper gas exhauster (or extractor) in a closed- or semi-closed loop to create a manual- or automatically-controlled depression of the system and, if synchronized with the gas flux blowing upwards through the screen of the fluid-bed, it provides enhanced control of the fluid-bed cooling effect.

In particular embodiments, this arrangement may provide benefits such as: (1) enhanced control of the final roasted bio-ingredient moisture; and (2) improved cooling time.

In one embodiment, closed-loop systems may synchronize (automate) the inert gas coming out from the process (to the separation cyclone & the condenser for the condensable gases coming together with the noble gases, such as the steam), with the intake of the fresh inert gas, which must be synchronized through (ventilation or exhausting) in order to ensure steady internal pressure of the operating fluid-bed system.

In certain embodiments, once the stream of fresh inert/noble gas+mixed condensable gas is injected (e.g. in case of steam for aroma stripping) & incondensable gases (e.g. noble gas) in closed-loop circulation in the system reaches the inner product been processed, there may be a significant heat and mass transfer when steam condenses, and transfers its latent heat to product,—depending on the specific processing conditions.

In particular embodiments, this humid gas may go through a cryogenic condenser in order to be dehumidified, while the system may re-inject part of the fresh inert/noble gas(es) into the returning gas(es) closed system, to compensate for small losses, and to keep up the heat and mass balance of the system. This while the incondensable inert/noble gas(es) is recovered and returns to the recovery gas system, through the separator.

In various embodiments, during the first part of the cooling process, a spray may be added. The spray may include a sugar (or other ingredient/food-grade additive in solution) containing between 5% to 60% by weight, and used as “torrefacto” operation, and carried out either at the roaster, or at the first stage of the F.B.D.&/orC.

According to various aspects of the present disclosure, the “Torrefacto” processing approach described above may be performed to impart particular flavors on the roasted beans.

In certain embodiments, this “Torrefacto” processing approach may also protect the roasted coffee against their precocity of oxidation, if the product is eventually exposed to atmospheric air.

In such a scenario, the first (1^{st}) stage of the F.B.D.&/orC. only receives the solution spray (with the cooler “off”),—while the second (2^{nd}) stage is employed to final quenching & cooling of the roasted bio-ingredient, thus, ensuring flexibility to the post-roasting & cooling conditions of the roasted beans.

### Metal Detection & Separation (Under Absence of Atmospheric Air).

In various embodiments, detecting and removing metal from the (roasted) bio-ingredient prevents damage to the mill during the subsequent cryogenic pre-milling phase.

Cryogenic Pre-Milling (i.e., operating in absence of atmospheric oxygen (air)—(targeting an average particle size of 75 to 500 microns).

In one embodiment, this step of the process is executed by pre-milling the roasted & cooled beans, which may be done by utilizing a few suitable commercial cryogenic or refrigerated inert gas-type dry mills. Among the available equipment, and also including cryogenic or refrigerated wet-mills, they both could be used in this invention,—the latter for certain bio-ingredients, such as in case of use for roasted cocoa beans, where there are specialized equipment such as the cryogenic operating-version of Pin or Turbo-mill, and other suitable cryogenic-operating impact milling models, already manufactured by companies such as Pallmann, Wolfstrasse 51, D-66482, Zweibrueken, Germany, and Hosokawa Alpine, Peter-Doerfler Strasse 13-25, D-86199, Germany,—the latter marketed as model MP. In any of those cases, it is, however, necessary to firstly modify the commercial equipment available, in order to ensure that both the inlet- and the outlet of the apparatus can operate their load-in and load-out steps under the absence of atmospheric oxygen (air).

In particular embodiments, these cryogenic dry- or wet mills are capable of pre-milling the whole roasted beans down to the desired particle size of the milled beans, at this stage, i.e. down to an average size of particles between 75 and 500 microns, but preferably between 100 and 400 microns (depending on the type of bio-ingredient in process). Mills' performance should ensure such process conditions, to avoid:
particles' over-heating.
air entrapment around the beans' particles, by preventing their exposure to the atmospheric oxygen (air) during the entire milling process.
wide dispersion of the outlet particles' size distribution.
   These, to ultimately prevent filter plugging, or formation of preferential channels in the extraction columns, during the subsequent next step process, i.e., the optional fat/oil extraction, using LCO₂-based S.C.F.E.

In one embodiment, this cryogenic dry- or wet pre-milling step is performed at a temperature range between +10° C. (plus) and −190° C. (minus), to ensure suitable brittleness (depending on the nature and type of bio-ingredients employed, and their degree of roasting utilized); this, to secure an efficient cryogenic milling (and regardless of the processing parameter conditions), utilized for the various types of beans processed.

(Optional)—Pre-mixing, using Modified and special Ribbon Blender (S.R.B.), operating under inert/noble gas(es) conditions, and capable of addition of various ingredients, in order to prepare composite formulae (in case of composite masses), and spraying onto the bio-ingredients' particles selected, fats and/or food oils (including—e.g., natural and/or deodorized cocoa butter, or combinations thereof).

In certain embodiments, the product obtained as described in the previous step, can be optionally pre-mixed (after cryogenic milling) with natural or deodorized cocoa butter or other suitable fat source, these preferred to be refined, bleached and deodorized (R.B.D.) vegetable food oil or fat (from 0.5 to 10%), based on the weight of the milled roasted bean, and the intended final oil/fat content & composition.

By utilizing a modified special industrial ribbon (or sigma type) mixer (S.R.B. or S.S.B, respectively), adapted to operate under closed- or semi-closed loop, and using any source of food-applicable inert/noble gas(es).

This step may completely exclude the atmospheric oxygen (air) from the process, while incorporating the fat/oil onto the milled beans.

In one embodiment, the amount of optionally mixed oils/fats is determined based on the amount, and general stability, of naturally occurring oils within the said original product. Alternatively, in any desired proportions, to satisfy the specific formula pursued.

In particular embodiments, the systems and methods discussed herein aim at adding a minimum amount of stable fat (e.g., deodorized- or natural cocoa butter) for improving the anti-oxidative resistance of the naturally occurring oil.

According to various aspects of the present disclosure, the special ribbon blender (S.R.B.) for these above discussed step(s) may be modified (or custom built) to maintain an inert gas processing environment and be added of liquid spray capability.

(Optional) Modified liquid carbon dioxide-based Super-Critical Fluid Extraction-(LCO₂-S.C.F.E.) Oils-Off & Recovery (under inert gas conditions), requires adaptation in both inlet- and outlet devices for operating under locked, and inert/noble gas(es) processing conditions, while preventing direct contact with atmospheric oxygen (air).

In one embodiment, and in this same above-processing step, the product may be submitted from partial to nearly-total extraction of fats/oils. In some embodiments, the carbon dioxide-based Super Critical Fluid-Extractor (LCO₂-S.C.F.E.) standard machine may be manufactured by Thyssenkrupp GmbH, Buschmuellenstrasse 20, D-58093, Hagen, Germany, under the Brand UHDE, Germany, Model No. 3×3100. In various embodiments, the machine may be modified to include extraction cells—as well as special loading and discharging apparatuses and systems, for ensuring the absence of oxygen (air) during the inlet- and outlet operations.

In various embodiments, this equipment encompasses two- or three-stage extraction columns, where carbon dioxide utilized is in form of liquid, and under super critical state conditions, is introduced into the permeation (filter) column.

In certain embodiments, the in-feed pre-milled bio-ingredient is loaded. In various embodiments, the temperature during this step may be kept between 30° C. and 90° C. (where an optimal temperature may be about 40° C.).

In one embodiment, the liquid carbon dioxide (liquid CO₂), under supercritical conditions, may be introduced at a pressure of approximately 150 to 450 Bars (where an optimal pressure may be in the range of 250 to 350 psi), to extract a variable and pre-defined amount (e.g., from 7% to less than 1%) of the original oil and/or fat content from the roasted & pre-milled bean product.

In certain embodiments, the extraction operation may be interrupted when the roasted bio-ingredient reaches a residual of seven percent (7%), or less, of fat/oil, depending on the intent and application of the specific finished product.

In one embodiment, if the (LCO₂-S.C.F.E.) equipment is equipped with two fluid collectors, it may be possible to separate the bio-ingredient's original oil from the added and/or natural fat present in the material and subsequently store the fat/oil (under cryogenic conditions). Alternatively, the fat/oil extraction could proceed to approximately 1% of residual fat/oil.

In one embodiment, the (LCO₂-S.C.F.E.), under particular configurations, may operate with two or more extractors (e.g., 2-3) and two or more separators (e.g. 2-3), which can operate under differential critical (& controlled) pressures.

Based on the principle of large differences between the boiling points between the fats (ca.+15° C. (plus) and the oils (ca. −28° C. (minus)), it is possible to work with differential critical pressures that allows the efficient separation between the two lipidic materials.

According to various aspects of the present disclosure, the fats and/or oils of the roasted & pre-milled bio-ingredients (typically, the natural “essential oil”), which have been dully preserved under cryogenic conditions, may be sprayed back (or “adding-back” operation) to the product's ultrafine particles at the fluid-bed drying & cooling stage, during the agglomeration, the microencapsulation, during the coating/instantization phase, or, alternatively, directly onto the already agglomerated granules.

In one embodiment, extracting the natural “essential oils” at the beginning of the process and furthermore adding the cryo-preserved oils back, after roasting, allows for the taste and flavor provided by the natural essential oils to be preserved, rather than they be compromised in quality during the roasting or heating and/or milling steps.

In some embodiments, such in the coffee's case, the “essential oils” may totalize about 11 to 15% of the bean mass and may be added-back, partial- or totally, to the product's powder or granules, (in variable possible %), when appropriate (e.g., during fluid-bed coating).

In some embodiments, natural and/or deodorized cocoa butter or other vegetable fat(s) and/or oils may be added. In various embodiments, the latter butters, fats and/or oils may be recovered in approximately pure forms during the LCO₂-S.C.F.E. phase, through appropriated variations in the system pressure of the carbon dioxide separators and furthermore reutilized to prepare a new product batch during the mixing phase already described.

In certain embodiments, the separated fat may be re-utilized in the modified ribbon blender, whereas the oil is protected from the process steps, under cryogenic conditions, until it can be added back at the end of the process, during the fluid-bed coating.

Modified Cryogenic Ball Milling (C.B.M.)—down to <0.1 (less than) to 25 microns (average particle size, operating under inert gas conditions). Noting that, with the smaller sizes, it is possible to improve certain rheological properties of the bio-ingredients and/or their processed products, due to the proximity to the colloidal properties achieved with their finer particles.

According to various aspects of the present disclosure, and at this step of the process, the goal is to convert the roasted and ultrafine-milled bio-ingredient to a processed and semi-finished product, envisaging potential commercial food and/or beverage-base applications.

In various embodiments, the roasted and pre-milled bio-ingredient's single, or composite mass is submitted to an ultra-milling stage, carried out under liquid inert gas (cryogenic conditions), to ensure that the final size of the bean or mass particles falls between (lower than)<0.1 and 25 microns, but ideally, not over 5 microns, in case of use such products for powder's dispersion use or preparations.

In certain embodiments, this may be accomplished by using available, however modified cryogenic ultra-mill equipment, manufactured by Hosokawa Alpine, Germany, equipment model MP, or other modified dry- or wet mill, or through a vertical ball mill, operating under cryogenic conditions, and commercially manufactured by the Union Process Machines, of Akron, OH, USA, manufactured under the Mod. S-30 Attritor. In all cases, the modification refers to specific adaptation and coupling of inlet- and outlet devices that ensures locked-in operating conditions under the absence of atmospheric oxygen (air).

In particular embodiments, the cryogenic ball milling process aims to mill to the smallest particle possible, with the largest particle preferably to a maximum of one (1) micron; Such resultant powder, when dispersed in liquid, indicates it is mostly stabilized due to colloidal effect in place.

In various embodiments, the systems and methods discussed herein may use cryogenic inert gas, such as liquid nitrogen (LN₂), for maintaining the processing temperature to approximately −190° C. (minus), and preferably, ensuring that the product reaches low temperatures at around −80° C. (minus) before it is milled.

In a particular embodiment, during the cryogenic process discussed herein, there may be direct contact between the product with the liquid nitrogen (LN₂) and therefore conditioning it under cryogenic conditions.

In some embodiments, for highly roasted pre-milled bio-ingredients, it is possible to efficiently mill the product utilizing non-cryogenic conditions, i.e., by simply using refrigerated inert gas(es),—provided that, during the entire milling process, the temperature is maintained below +10° C. (plus). This condition may prevent the product from overheating during the milling process.

According to various aspects of the present disclosure, the process discussed herein may be carried out in its entirety under cryogenic conditions, thus allowing the product's particles to exhibit fluidity-like properties, and furthermore allowing for the reduction of particle size for the desired (colloidal) spectrum, due to improved dispersibility of the solid particles in liquids.

In certain embodiments, and in a subsequent step of the process, the roasted & pre-milled beans may be milled once again (i.e., through a 2^{nd}. Milling), now using a closed- or semi-closed loop jet mill, cryogenic or refrigerated inert gas mill, or any dry- or wet-milling-type equipment, and capable of generating ultrafine particles.

In various embodiments, the equipment for this ultra-milling step, may be similar to equipment manufactured by several companies, such as Fluid Energy, 4300 Bethlehem Pike, Telford, PA 18969, and marketed under model Jet-o-Mizer. In any possible case, maybe, it will require the design, construction and coupling of both inlet- and outlet devices to the standard equipment, to ensure that the entire processing step is realized in absence of atmospheric oxygen (air).

In a particular embodiment, milling at this step is based on high-speed inter-particles' collisions, and may ensure ultra-milling, as desired, for bringing particle size to an appropriate size and therefore for exhibiting the desired colloidal state/effects.

The roasted bean particles are brought between <0.1 (less than) and (less than) twenty-five (25) microns, being the preferred average size from five (5) to (<0.1) (less than) micron,—depending on the specific application pursued. The result being that the particles become indeed ultrafine powder that requires special filtering equipment, to prevent dusting/losses during handling. The ultrafine powder is always then kept under an inert gas condition, to prevent rapid flavor deterioration.

In an optional embodiment, the formulation and mixing with other ingredients, and/or food-grade additives (under inert gas conditions) may be carried out. In certain embodiments, the product described in the previous step may be (optionally) pre-mixed with natural and/or deodorized cocoa butter or other suitable vegetable food oil or fat (from 0.5 to 10%), based on the weight of the roasted & milled bean,—by utilizing an standard industrial ribbon (or sigma type) mixer, however especially adapted to operate under a closed- or semi-closed loop, and by using any source of inert gas in closed-loop, preferably w/built-in liquid spraying capabilities (S.R.B. or S.S.B.).

In one embodiment, the equipment used in this step may be customized to completely exclude atmospheric oxygen (air) from contacting the roasted & milled beans, while incorporating the fat/oil onto the roasted bean mass (or particles), through means of spraying nozzles or similar devices.

In some embodiments, at this step, the roasted & milled beans may be incorporated with other food-grade materials/ingredients/additives/aromas,—such as sugar, milk, free-flowing agents and/or flavoring; this, to diversify potential end-products and applications for the milled beans.

In an optional embodiment, the modified & special S.P.R. (Solid Phase Reactor), such as modified & special high-pressure extruder (S.H.P.E.) or Special Conche (S.C.) are used for processing of the bio-ingredient's single liquor (e.g. roasted & milled cocoa), and/or single mass (e.g. roasted & milled coffee formulae), and/or other composite formulae (carried out in absence of atmospheric oxygen (air), and optionally coupled with a standard aroma recovery system (A.R.S.), consisting of one steam stripper/distillation & fractionation column (S.D&F.C)+one cryogenic condenser unit (C.C.U.) apparatuses.

In one embodiment, and for this step of the process, a set of unit-operations is combined to deliver the desired result. In various embodiments, it may be convenient to utilize a modified & special High-Pressure Extrusion (S.H.P.E,) machine, preferably double-screw, to operate under variable pressure (from 14.6 to ca. 3,500 psig), with a preferred pressure of about 1 to 2 bars for beans, while the entire processing of the bio-ingredient is conducted under any suitable inert/noble gas(es) conditions, to ensure that the desirable Maillard reactions, Strecker degradations and/or Schiff reactions may take place without the inconvenience of concomitant flavor deterioration, and/or the formation of off-flavors, and/or of harmful chemicals for human health.

In particular embodiments, at the edge of the special high-pressure extruder, the equipment makes the product abruptly expands, due to the eventual sudden depressurization (if operating under pressure, down to 14.6 psig, and under inert gas conditions), or achieving variable flashing-out conditions,—depending on the differential pressures established in the particular process.

In embodiments for special high-pressure extrusion (S.H.P.E.), and as an alternative to special conche (S,C.), the system may work, as a modified version of the standard commercially available extrusion equipment, because it requires in this invention to operate with both inlet- and outlet,—respectively feed-in and flash-out conditions, both operating under inert/noble gases) environment, and therefore they must be equipped with special sealed inlet/outlet devices, built-in hermetically coupled to the high-pressure extruder apparatus, which may be operating under one or two screws, and the screw(s) surrounded with cooling jackets, operating under cryogenic or refrigerated (i.e., from +10° C. (plus) to −190° C. (minus), while the inner apparatus operates under inert gas conditions, in a closed-loop configuration (or operational conditions). The processing times should be from one (1) minute up to one (1) hour, maximum temperatures of +70° C., and the apparatus equipped with special types of screws (threads, root, crest, pitch, chamfer, etc.), special type of dies, as well as other minor special processing devices and process parameters proper for such operation.

Alternatively, the bio-ingredient and/or other ingredients and/or other food-graded additives may be jointly processed, using an especially modified, closed- or semi-closed loop, distinct layout version of a traditional industrial chocolate conche, such as for example, the one supplied by Buehler AG, Uzwil, Switzerland. The modified & special conche (S.C.) requires to be especially adapted for conching processing & operation under vacuum, vacuum-compensated or pressurized conditions,—where the latter two are conducted using inert/noble gas(es) conditions (i.e., in absence of atmospheric oxygen (air), and especially equipped with certain gadgets & features, and utilizing certain distinct process parameters, as defined in various embodiments, and more specifically as following:
Distinct processing profiles of temperature: (from 10° C. to 80° C.—dependent upon the processing phase, but preferably between 10° C. and 70° C.).
If using pressurized or pressure-compensated conche version: (from 1 to 5 Bars, but preferably between 1 and 2 Bars), using inert/noble gas(es) as partial- or total compensated (inner) atmosphere.
Processing cycle/timing: (from 1 to 24 hrs., but preferably around 4 hrs.); and
Shaft rotation speed: (from 25 to 150 rpm, but preferably around 50 rpm, having special paddles with the ability to counter-rotate the mass during the wet-conching phase

In certain embodiments, the special conche (S.C.) described above may be adapted/modified to operate in closed-, or semi-closed-loop, allow load-in of various food-grade ingredients and/or additives under absence of atmospheric oxygen (air), operate under inert/noble gas(es) conditions, installed with recovery/recirculation system of the gas(es), fluid-dynamically designed to facilitate additional flavor-generating reactions during the processing phase of the masses, generate convenient finished reaction products, and optionally, to allow stripping of off-flavors and/or recovery of the aromas for future add-back.

In some embodiments, the special conche (S.C.) may be equipped with a custom device for the under-bed injection of condensable sanitary steam/S.H.S., operating under inert gas closed-loop conditions and with subsequent extraction ability to recover condensable gases through an add-in aroma recovery system (A.R.S.), consisting of one (1) steam/SHS stripping, distillation & fractionated column+one (1) cryogenic condenser unit apparatuses. In one embodiment, the process uses S.H.S. (Super-heated Steam), injected at various temperatures and pressures, goes through the product's being conched, injecting on the conche's fine perforated bottom bed, done in an upward flow direction, and under conditions of a min. volume of 0.1 to 5% and a variable time from 0.1 min. to 60 min., all calculated in relation to the initial product mass, and to the total process cycle, where the special conche (S.C.) is (optionally) coupled to an aroma recovery system, consisting of firstly, to a steam/S.H.S. stripping-distillation- and/or fractionation (2-5 trays)-type column, and secondly, to a cryogenic-type aroma condenser unit (C.C.U.), for the recovery of flavor volatiles. In this system, while the off-flavors are initially eliminated (considering the 1^{st}. flow of 0.1 sec. to 10 min. steam stripping injection) and the non-condensable fraction is separated & returned from the mixture of steam/inert and/or noble gas(es) through the system's closed-loop, the other stream, consisting of the condensable-recovered fraction, and containing the aroma, is cryogenically recovered and stored, before it may be subsequently added-back to the product, at the end of the micro-encapsulation, agglomeration and/or coating/instantization phase of the process.

In particular embodiments, a type of Aroma Recovering System (A.R.S.), whose equipment consists of two stage processing, and may include: (1) a steam stripping stream+distillation/fractionation (2-5) trays-type column, operating in two phases, and equipped with a steam stripping stream (1^{st} phase) for the initial off-flavor elimination,—while the 2^{nd}. phase consists in the steam distillation &/or fractionation of the desirable aroma profile the condensable (steam/aroma) is directed to the cryogenic condenser unit for aroma recovery. In the process, the incondensable (inert/noble gas(es) is separated and returned in the closed loop of the inert/noble gas(es) recovery & recirculation system. In certain embodiments, the base of the distillation column may be connected to the top outlet of either the modified & special Conche (S.C.), or to the modified & special H.P. Extruder (S.H.P.E.).

The steam/S.H.S.-based (fractional) distillation apparatus may include various distillation trays (e.g., 2 to 5), specifically designed to allow for selected individual tray outlets, separation outlets (condensable/incondensable vapors), and it is followed by a special designed device unit for fractional condensation of the aroma volatiles, operating under cryogenic conditions.

In certain embodiments, the individual steam/S.H.S. stripping distillation & fractionation may converge to at least two (2) trays column, for stripping and aroma separation, whose outlet is connected to an Aroma Recovery System (A.R.S.). The system disclosed herein may be achieved via a modified EPIC type Processing Systems machine, a manufacturer located at 4141 Meramec Bottom Rd, St. Louis, MO, USA.

In particular embodiments, the modified aroma recovery system (A.R.S.) can be coupled with either the outlets of the modified & special conche (S.C.) or the modified & special high-pressure extruder (S.H.P.E.), and consists of two (2) interconnected apparatuses: The 1^{st}., may be utilized as a steam/S.H.S. stripping distillated & fractionated column, whereas the 2^{nd}., may be utilized for the recovery of aromatics, though means of a cryogenic condenser unit. The latter, as a stand-alone unit, is a type of standard equipment utilized in chemical, perfumery and cosmetic processing, is commercially available and may be supplied by Bufflovak LLC, of Buffalo, NY, USA.

In various embodiments, this equipment may be utilized for the cryogenic recovery of volatiles, and the recovered product may be used as add-back of several volatiles that escape through the condensable+incondensable gases stream, and stripped from the initial stage (drying stage) and/or the 2^{nd}.—or liquid stage) of the processing, done at the special conche (S.C.). Alternatively, it could also be done during the special high-pressure extruder (S.H.P.E.).

F.B.D.&C.—Agglomeration (batch or continuous) &/or Micro-encapsulation (batch- or continuous), and carried out under inert gas conditions, is applied for finished bio-ingredients or food/drinkable products obtained in form of powder.

In certain embodiments, in this processing step, the ultrafine powder can be either directly micro-encapsulated or simultaneously agglomerated and/or instantized/coated at the same equipment. Either option may provide protection against oxidation, while it may also confer an improved dispersibility and beverage stability, during its beverage preparation (from powder) into a liquid dispersion.

In various embodiments, if the powder is micro-encapsulated, the process may be carried out by directly spraying the ultra-fine powder with suitable food ingredients and/or food-graded additives, to confer improved dispersion and stability of the micro-encapsulated bio-ingredients or finished foods' particles, during beverage preparations (from powder).

In some embodiments, the process is carried out in a closed- or semi-closed loop fluid-bed drier and/or cooler (F.B.D.&/orC., or “the agglomerator”), operating under refrigerated inert gas, and a dehumidified environment condition. In various embodiments, this can be accomplished in batch or continuous fluid bed-type equipment or, alternatively, by using any of the following equipment: a closed- or semi-closed loop, commercial spray-(drier, cooler, or freezer), or freeze-drier, and operating under inert/noble gas(es) atmosphere.

According to one exemplary process, the ultra-fine powder may be initially agglomerated under refrigerated inert gas conditions, in a closed- or semi-closed loop fluid-bed (dryer and/or cooler)-type “Agglomerator” (batch or continuous). The resulting ultrafine powder (either from the micro-encapsulated step, or from the agglomerated particles) may be kept inside a chamber under dried conditions, or/and we could apply an food-approved anti-adherent inner coating of the apparatuses' inner walls, and operating under inert/noble gas(es) atmosphere.

In one embodiment, this may optionally substitute the micro-encapsulated ultra-fine milled e.g., coffee or cocoa particles or other agglomerated ultrafine powder from adhering to each other, or through the use of a food-approved anti-adherent inner coating to the inner walls of the fluid bed unit, while operating under inert/noble gas(es) atmosphere.

In particular embodiments, and in the case of direct fluid-bed microencapsulation of the micro-particles, the fine particles are individually coated through a type of spray-cloud, done under inert gas environment, and applied to bio-ingredients, or finished food products, already in the form of ultrafine powder.

In particular embodiments, as applied to non-previously agglomerated particles, in a closed- or semi-closed loop fluid-bed (dryer and/or cooler)-type “micro-encapsulator” (batch or continuous),—it may be applied a coat of finely sprayed coating: (1) the natural essential oil(s), previously obtained from any of the bio-ingredients being processed,—as well as (2) any of the pre-selected specific food ingredient(s), and/or food-grade additive(s) as micro-encapsulating solutions and/or dispersions. They may be simultaneously pulverized through means of built-in device, or special inner spray nozzle(s),—configured and positioned to provide an efficient coat to the individual ultra-fine particles, while they are under fluid-bed suspended. The exemplary process includes:
Pre-wetting (with cold water),
Agglomeration,
Drying, and
Cooling the on-going formed agglomerates.

According to various aspects of the present disclosure, this may be achieved by continuously micro-spraying suitable food ingredients and/or food-grade additives, through means of internal nozzles,—especially configured to apply film coating onto the pre-agglomerated particles, the total spread content from 0.5% to 15% weight/weight of the coffee granules.

In particular embodiments, the spread content may vary to accommodate a desired level of protection and level of physical-chemical or rheological improvement sought for the properties of the agglomerates,—whenever they are dispersed into food liquids, either hot or cool.

Product Instantization & Protective Coating (under inert gas conditions), under Optional Adding-back of Natural Oils & other bio-ingredients and/or food-grade additives.

In particular embodiments, the fat and oil, previously extracted from the roasted, and pre-milled bio-ingredients (e.g. natural essential oil),—and dully preserved under cryogenic conditions, might then be further sprayed-back (a process called “adding-back”) to the product particles, done at the fluid-bed drying stage, during the micro-encapsulation (of the ultra-fine powder), or to the agglomerated granules, during the coating (protective) phase.

In various embodiments, a preferred coating may include less than 15% w/w (percent mass to mass), and spraying may range from 1-30% w/w (percent mass to mass).

fluid-bed drying &/or cooling (F.B.D.&/OR C.)—designed in forms of:
a “Particles' Agglomerator”; and/or
a “Particles Coater”; and, in both cases, operating under inert gas conditions.

In one embodiment, this step of the process utilizes a two-stage vibratory fluid bed drier &/or cooler (F.B.D.&/orC.) to control the cooling of the roasted, milled, agglomerated, and protected bio-ingredients and/or derived products.

In particular embodiments, a closed- or semi-closed loop inert gas, two-stage fluid bed cooler (F.B.C.) can be modified from the standard model offered by the Food and Pharma Line, and manufactured by Witte, 507 Rt. 31 S. Washington, NJ-07882, to ensure the inclusion of the entire equipment under an O₂-absent processing operation.

In various embodiments, the product, in form of agglomerated and coated particles may be subsequently cooled down, under absence of oxygen (air), from a temperature between +50° C. to +100° C., but most preferably between +65° C. and +75° C. for at least 1 (one) minute, to acceptable ambient temperature, i.e., considered as between +18° C. and +25° C.

In one embodiment, this is achieved through the cooling stage by means of receiving a pressurized blow through the fluidized bed of cooled inert gas together, with the aid of mechanical vibratory screen to transport the particles forward, and under a complete absence of atmospheric oxygen (air).

In some embodiments, the cooled particles are loaded in a tote-bin type system, to facilitate the loading of the finished product silos for primary packaging, while the inert/noble gas(es) atmosphere is maintained, or alternatively, pneumatically transported, using inert/noble gas(es) as the transport medium, in closed-loop arrangement.

### Packaging (Under Inert Conditions)

In particular embodiments, the resulting agglomerated product or coated powder (or granulated products) can be packaged under a wide range of packing options, including (but not limited to): aluminum-plastic complex, B.O.P.P., paper, plastic, glass, metal or combinations thereof, being a requirement in all cases that the packaging materials offer effective barrier against atmospheric oxygen (air).

In various embodiments, it is highly recommended that the powder and/or granules are packed under vacuum-compensated inert/noble gas(es), or vacuum conditions, to secure longer shelf life (over one year, to a maximum (observable) of up to 5 years,—depending on the specific processed bio-ingredient or processed food product); it can be extended further and/or maintained, due to eventual imperfections in the coating process of some of the particles.

The foregoing detailed description conveys the best understanding of the objectives and advantages of the present invention.

Different embodiments may be made of the inventive concept of this invention. It is to be understood that all matter disclosed herein is to be interpreted merely as illustrative, and not in a limiting sense.

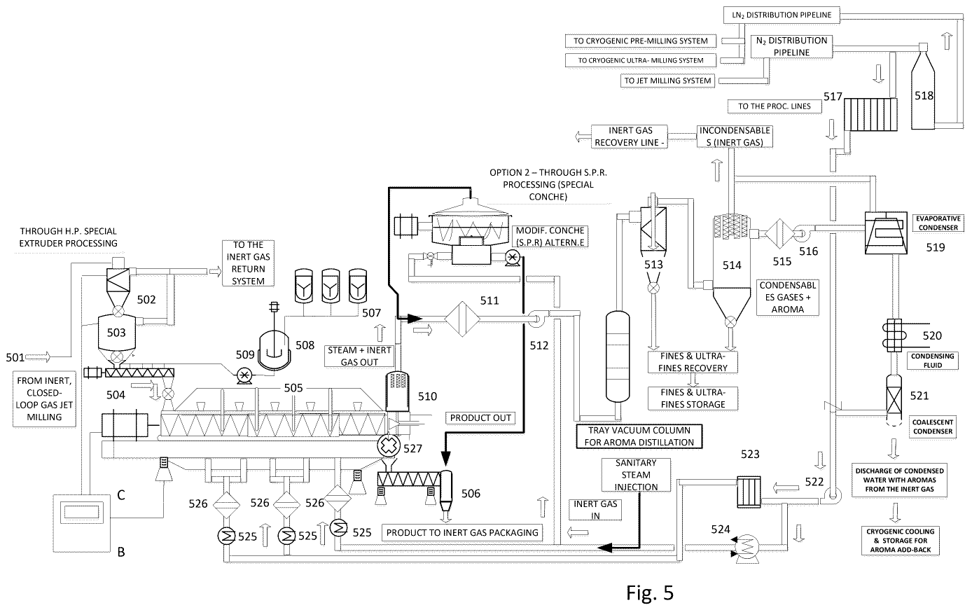

FIG. 5—Alternative embodiments and processes. FIG. 5 shows ultra-fine particle loading 501, load-in cyclone 502, intermediary storage silo 503, screw feeding system 504, continuous, modified high-pressure extruder unit 505, processed beans granules discharge screw 506, food ingredients/additives tanks 507, enclosed additives' boiler 508, positive displacement dosing pump for the screw inlet nozzle sprays 509, flash-out exhaust gas from the h.p. extruder w/filters 510, HEPA line filter 511, exhaust gases fan 512, gas-solid separation cyclone 513, filter bag tank 514, HEPA line filter 515, HEPA line filter 516, inert gas heat exchanger 517, inert gas primary tank 518, evaporative condenser 519, condenser fluid unit 520, coalescent condenser 521, inert gas blow fan 522, inert gas secondary heat exchanger 523, post-condenser 524, inert gas secondary heat exchanger 525, HEPA filters 526, and extruder die & flash-out valve 527.

FIG. 5 illustrates an exemplary system diagram, according to various aspects of the present disclosure; and presenting:

### Example 1—Exemplary Dual-Stream Process (e.g., Coffee)

In one embodiment, both the coffee processing steps and the non-coffee food materials processing steps may be separated into at least two separate streams of processing (e.g., dual stream).

In various embodiments, the streams are separated at the beginning of the process (or at an early processing step), and the two streams are joined (or the non-coffee food materials are combined) at later steps in the process (e.g., the end of each stream).

According to various aspects of the present disclosure, the resulting product is a coffee-based mass that may be shaped into coffee bars.

In particular embodiments, in the first stream, coffee (or another appropriate bio-ingredient) is converted into single coffee mass, via special cryogenic wet- or dry milling.

In certain embodiments, this single coffee mass is stored as a functional bio-ingredient and may be prepared for blending with other food ingredients and food-grade additives.

In some embodiments, this process is estimated to take up to 2 hours, but generally takes less time (e.g., and typically, from 10 minutes, to around 1 hour).

In parallel to the first stream, the second stream is implemented, where the second stream includes the other non-coffee food ingredients for making coffee bars.

For example, the second stream may process other food ingredients such as sugars, dairy derivatives, complementary fat systems, maltodextrins, etc.—depending on the envisaged formulae.

In one embodiment, the second stream may be carried out using a “special conching” process, which initially eliminates/minimizes off-flavors from selected ingredients, dramatically reduces residual moisture, induces changes in the rheology of the mass, and promotes flavor reactions, such as the Maillard reactions, through this modified & special (S.P.R.)—solid phase reactor.

In certain embodiments, the typical processing time for loading, dry conching, (partial) wet conching, (partial) homogenization, and wet milling (through recirculation), may take up to 4 hours, but generally takes less time (e.g., typically, from 10 minutes to around 2.5 hours).

In response to completing the processing of the second stream, the first stream may be transferred to the modified & special conche (S.C.), and subsequently blended with the product from the second stream (to complete its homogenization), under absence of atmospheric oxygen (air) processing conditions.

In various embodiments, the resulting product may then be prepared for tempering, molding and packing, and all the time maintained in absence of atmospheric oxygen (air)-processing conditions.

According to various aspects of the present disclosure, the exemplary dual-stream process may reduce the overall industrial cost, reduce the industrial processing time (from up to 13 hrs., down to around 3.5 hrs.), increase product uniformity of the finished product, i.e., obtaining the coffee or cocoa mass homogeneity within a narrower particle size distribution and within a targeted viscosity, and also allowing to reduce the overall fat percentage levels of the finished coffee or the chocolate-derivative product(s),—while extending the shelf-life of the finished products.

In the case of cocoa & chocolates, for achieving balanced and full-bodied roasted cocoa, cocoa of different origins and/or different levels of roasting are sometimes separately processed and then combined, to impart better chocolate's overall flavor profile.

In various embodiments, including more than one type and roast level of cocoa may affect the rheology of the cocoa or chocolate mass during the wet-milling process, where its cellulosic and hemi-cellulosic composition behaves as a plastic,—thus absorbing the impact effect of the mill, and therefore prolonging the time necessary for the milling to reach around twenty (20) microns.

While this happens, the non-cocoa bio-ingredients present in the recipe are in practice over-milled, to a wide particle size range, from about six to eight (6-8) microns, and up to the target of 20 microns. This condition frequently requires extra fat added in the formula, to inter-lubricate the particles, in order to reach the desired apparent viscosity, which therefore implies extra processing costs (as butter is generally the second most expensive ingredient, immediately after the cocoa itself).

In various embodiments, the present disclosure discusses a unique solution encountered for the timely and efficient milling of cocoa at lower microns in fewer minutes than conventional methods, while maintaining a narrower particle size distribution, because it allows for the coffee particles to transition from a plastic—to a glassy state, thus allowing fracturing more efficiently the plastic-like particles (such as cellulosic- and hemi-cellulosic components), whenever they are re-conditioned to the desired glassy state.

### Example 2—“Conch-Less” Processing of Cocoa or Other Bio-Ingredients

In one embodiment, the present disclosure discusses methods for processing cocoa, chocolate or other masses from bio-ingredients and/or from derivative food products, via the use of a distinct solid reaction process (rather than the classical “Swiss-type” conching methods).

According to various aspects of the present disclosure, wet milling (through recirculation) occurs at the end of the homogenization/plasticization stage (and not before the dry conching, as per one exemplary “Swiss” method).

In various embodiments, the alternative of traditional conching process is achieved by implementing alternative/modified/novel equipment & unit-operations, via the adequate selection & sequence of equipment including the following: (see the equipment listed below)

### Equipment #1: Modified & Special Ribbon Blender (S.R.B.)

In various embodiments, ingredients (except the free fat, lecithin, vanilla, and any other additive) are initially loaded into a modified & special mixer (Ribbon, Sigma, or Nauta-types), in such a case operating under a closed-loop & inert/noble gas(es) atmosphere, where the ingredients are pre-mixed until reaching a homogeneous mass.

Equipment #2: Modified Two-Stage Fluid Bed Dryer (and/or) Cooler (F.B.D.&/orC).

In one embodiment, the mass is dried (to below 1.5% residual moisture) via a two-stage fluid bed dryer and/or cooler (F.B.D.&/orC.), operating in a closed- or semi-closed loop, utilizing any suitable inert/noble gas(es), thus preventing the bio-ingredients and/or mass under processing any contact of with the atmospheric oxygen (air), and completing both the drying, and cooling phases of the process.

### Equipment #3: Modified & Special, One- or Twin-Screw, High-Pressure Extruder (S.H.P.E.).

The resulting product, with a residual moisture of less than 1.5%, is loaded into a feed hopper for feeding the modified special high-pressure extruder (S.H.P.E.). In one embodiment, an auger feeder with feed (inlet) controls the flow, and the unit is locked for both load-in and load-out of the product in complete absence of atmospheric oxygen (air).

The modified & special high-pressure extruder (S.H.P.E.)'s construction and technical features may be designed to impart the transformation of bio-ingredients, by promoting a more efficient solid-phase reaction.

Thus, in at least one embodiment, the proposed alternative process provides a dramatic increase in the flavor formation (reaction), due to at least, the following:
Low moisture of the infeed product, which favors the Maillard's reaction (and other reactions), facilitating immediate flavor development.
The combination of high process shearing, high friction, and high temperature,—as well as lower processing time within the extruder, facilitates a higher intensity degree and efficient control of the Maillard reaction (and other desirable secondary reactions),—while the absence of atmospheric oxygen (air) prevents oxidation at increased rates due to elevated pressure and temperature; and
The low-fat content of the pre-mix provides efficient reactive surface for the solid particles to increase solid phase reactions due to precise processing conditions within the special high-pressure extruder, whereby the traditional conching-alternative effect process could be dramatically accelerated (i.e., from 5-24 hrs. to less than 10 minutes, in certain products).
Process parameter optimization allows for obtaining throughputs of homogeneous product formulations.

In one embodiment, the special high-pressure extruder (S.H.P.E.) may leverage an inter-meshing through the twin-screw configuration, including the various features, below described:

The equipment may be designed and assembled in a special structure, including a heavy bed plate where six heavy steel supporting columns are attached to the apparatus (four for the main twin barrel, while the other two support the apparatus set), including a screw-type drive motor, equipped with a frequency inverter (for precise rotation control at variable torque demanding by the process), a reducing gearbox and a closed-loop operating hopper load-in feeder/load-out discharge system, both operating under the absence of atmospheric oxygen (air).

A central panel is equipped with a number of essential controls, including: motor switches, band heater controllers, thermostat, thermistor or thermocouple control switches, cryogenic gas expansion valves for the cooling system, P.I.D. for (barrel) temperature gauges, heating and cooling elements & controls, opening of the twin screw main body (barrel or stator) for easy cleaning & sanitation, pressure gauges for the main barrel's reaction areas, the screws feeder, the armored revolving screw changer, screws rotating input/output, metering pumps dosing, feed rate input/output, screws torque, die temperature, rotary knife (cutting system) types and rotation, safety controls and other essential and secondary controls for the system.

The barrel may be jacketed and equipped with efficient systems for both cooling and heating (per each section of the twin screws, i.e., all along the processing extruder barrel's from 2 to 10, but ideally 3-5 screw processing sections), with precise temperature controls, from +1° C. to +90° C., and at pressures ranging from 1 to ca. 241 bar (14.5-3,500 psig). In one embodiment, the system may also include removable liners for the barrel covers, pressure gauges and sensors in the key transition (processing) areas of the barrel, two other insertion areas, and where ingredients can be added directly into the barrels (respectively for eventual addition of various/special reactants and for heat-sensitive additives, in precise timing and/or processing conditions).

The twin-screws may be specially designed, where the screws are alternatively designed (or modified), to include fabrication changes to the screws root; channel width; flight; axial flight width; helix angles; pitches (variable) (the screw clearance); barrel length; barrel diameter; and special twin-screw designs, aiming at providing precise and controllable reaction rates, time-temperature and reaction times.

The edge of the twin-screw barrel may include a natural vacuum degassing port system for facilitating degassing and volatilization, integrated with the breaker plate, where there is extrusion head, the pipe die, a screen pack, and the rotary knife's cutting system, from where the extruder product exits in a closed-loop chamber with a stream of inert gas that mixes with the exhausting gas, and is directly coupled to a fractionation column for initial stripping off-flavors vent & subsequent volatiles (cryogenic) recovery, while with a coupled separation, and return line of the incondensable gases, in a closed-loop that ensures an inner process conditions operating under inert/noble gas(es) and consequently, in absence of the atmospheric oxygen (air); and for selected special roasted products, the equipment may also be additionally equipped with a secondary vacuum sizing system, which may be coupled to the outlet of the main extruder, which allows for the process to operate with vacuum, controlled reaction (cooled with circulation of cooled refrigerant gas), thus further facilitating the control of the end-process reaction.

In certain embodiments, the extruded bio-ingredient's mass product may be a type of chocolate or coffee in flavor and taste, and furthermore, exiting from the extruder in an irregular solid form (depending on the “die” utilized in the extrusion process).

Equipment #4: Modified Cryogenic Ball (Coarse) Milling and/or Modified Cryogenic Ball (Ultrafine) Milling (C.B.M.—1^{st}. And/or C.B.M.—2^{nd}.)

In one embodiment, the product exiting (or “flashed-out”) from the twin-screw extruder, may be subsequently (e.g., immediately) cooled through direct contact with the cryogenic (inert) gas, through means of a spray placed inside the screw conveyor that receives the extruder outlet and feeds the extrudate from the top down.

In various embodiments, the product may be processed when its temperature reaches about −80° C. (minus), so that the bio-ingredient is completely in a brittle or “glassy” stage.

In a particular embodiment, the process may implement stainless steel milling balls of various diameters, for example, with diameters of 0.5 and 0.7 mm, intermixed at convenient proportions (e.g., 60:40), and milling at a speed of ca. 250 rpm, and operating at cryogenic conditions.

According to various aspects of the present disclosure, the process may mill particles to lower than 20 microns, typically in around 20 minutes (under industrial-scale conditions).

It is relevant to disclose that this process renders masses of higher viscosities, proportional to the average size of the milled particles, being higher than the average size of the particles, due to the increased inner surface of the particles for the same amount of fat (the particles' lubricant) content and/or added.

### Equipment #5: Modified & Special Ribbon Blender (S.R.B.), Used as Bio-Ingredients' Composite Food Mass Mixer (or for Formulae Preparation).

In particular embodiments, for using the product as chocolate, the product can be mixed with natural-(generally used during the dry-phase of special conche processing) and/or deodorized cocoa butter (used during the liquid-phase of special conche processing, in order not to introduce off-flavors to the chocolate mass) and/or other suitable fat/oil system combinations (generally RBD type), according to its planned product and/or end-use.

The finished product may be versatile for use in food and beverage applications, such as in (but not limited to): formulation of chocolate bars, chocolate powders, chocolate spreads, and a variety of applications in refrigerated or frozen desserts, sugar and/or chocolate baked goods, breakfast cereals, power bars, etc.

In one embodiment, the modified & special Ribbon Blender (S.R.B.) apparatus may include: a double helicoid rotating shaft with ancillary paddles, and stator devices to facilitate the creation of turbulence during the mixing operation, and also equipped with a spraying nozzle system for liquid foods, oils and/or food-grade additive(s) applications.

In various embodiments, the modified & special ribbon blender (S.R.B.) apparatus may be designed to operate in closed- or semi-closed loop and under suitable inert/noble gas(es). Depending on the end use of the product, the processing temperature may range between +1° C. (plus) to +70° C. (plus) via heated and/or cooled equipment walls.

In some embodiments, the modified & special ribbon blender (S.R.B.) apparatus may exhibit variable rotation ranging from 10 to 150 rpm.

In various embodiments, the modified & special ribbon blender (S.R.B.) may be equipped with an efficient fat/oil spraying system, to facilitate uniform incorporation into the masses.

Other ingredients and additives may be employed at this stage, such as lecithin's, P.G.P.R. (Polyglycerol Polyricinoleate), and various other food-grade additives, with diverse applications.

The equipment (S.R.B.) must be constructed in sanitary design and may be designed for easier cleaning and sanitizing. Processing times are variable, however they are typically between 5 min to 1 hr., depending on the specific product and/or formula, and applied processing technology.

The equipment (S.R.B.) may be assembled on a platform to facilitate the discharge into inert gas locked-in totes, silos, or directly to the feeding silos, via oxygen absent (air) special pneumatic transporters, using inert/noble gas(es) to the packaging line.

Equipment #6: Aroma Recovery System (A.R.S.)—it is a Combined Steam/S.H.S. Stripping/Distillation & Fractionated Trays-Type Column Apparatus, Combined with a Condensable/Non-Condensable Gases Separators (G.S.) and Cryogenic Condenser Unit (C.C.U.) Apparatus Located at the Down-Stream.

In one embodiment, the system may combine a total injection of 0.1 to 15% of water vapor/superheated steam (S.H.S.) at various pressures and temperatures in the primary solid-phase reactor (S.P.R.), generally due to the initial dry-phase of the processing through the perforated bed of the special conche (S.C.), or through the entrance shaft of the special high-pressure extruder (S.H.P.E.) for the initial stripping operation, to eliminate the initial off flavors of the bio-ingredients' composite mass being processed, stream that is initially eliminated through venting, followed by the subsequent steam injection, which is then goes through the distillation & fractionation column, followed by incondensable gas(es) separation and recovery through to the internal, closed loop of the inert/noble gas(es) while the condensable, containing vapor and the aroma volatiles, are recovered through a cryogenic condenser unit. In some embodiments, the system (processing temperatures) may reach up to +75° C.

According to various aspects of the present disclosure, extraction and cryogenic condensation of the volatile organic compounds (V.O.C.s) may be achieved through a controlled injection of any suitable, condensable inert gas (such as steam) by means of passage through the stripping/distilling & fractionation column, and finally condensed through the cryogenic condensing unit. Within the distillation & fractionation column, the stream of (volatile) gases may pass through successive trays (typically 2 to 5 trays), which are differentiated through inner circulation of liquids or gases at various pressures and/or temperatures.

In various embodiments, the volatile gases (e.g., steam, aromas and flavoring) are finally recovered as condensates (from the collection streams of the trays) of these streams, under cryogenic conditions, and the recovered flavor fractions may be “added-back” to the main conched or extruded food mass, at the end of the processing steps, and immediately before packaging.

According to various aspects of the present disclosure, the process may be continuous-, semi-continuous, or batch-types and may operate in synchronization with the previous processing stage(s).

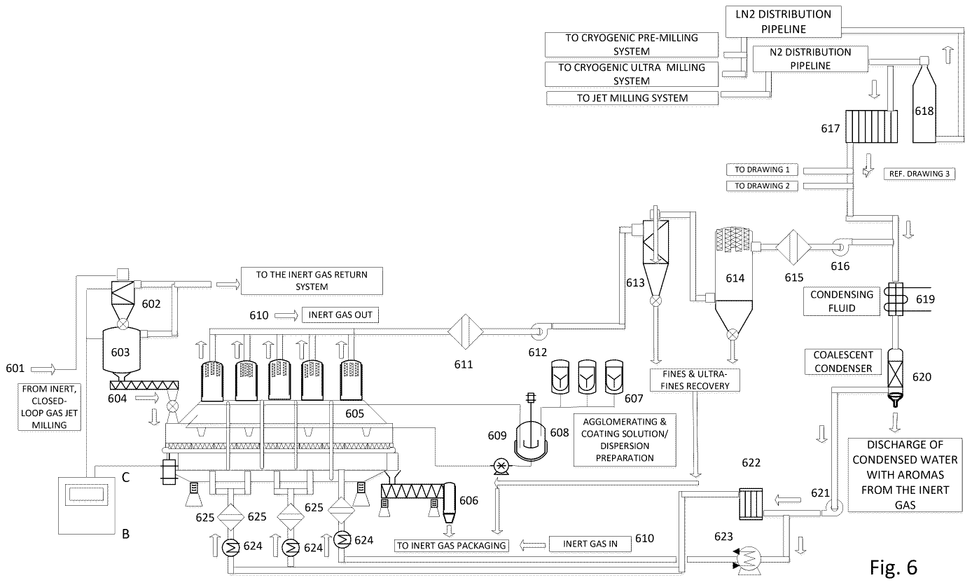

FIG. 6—alternative embodiments and processes-FIG. 6 illustrates an exemplary system diagram, according to various aspects of the present disclosure. FIG. 6 shows ultra-fine particle loading 601, discharge cyclone 602, load intermediary storage 603, screw feeding system 604, 4- to 5-stage continuous F.B.D.&C. unit 605, coffee granules discharge screw 606, food ingredients/additives tanks 607, enclosed coating boiler 608, positive displacement dosing pump for the nozzle sprays 609, inert gas pipeline network 610, HEPA line filter 611, inert gas exhaust fan 612, separation cyclone 613, filter bag tank 614, HEPA line filter 615, inert gas fan 616, inert gas heat exchanger 617, inert gas primary tank 618, condenser 619, coalescent filter & condenser 620, inert gas blow fan 621, inert gas secondary heat exchanger 622, post-condenser 623, inert gas secondary heat exchanger 624, and HEPA filters 625.

### Example 3—Exemplary Agro-Industrial Processing Steps: Example of the Cocoa Beans Processing-all Conducted in the Absence of Atmospheric Oxygen (Air)

In one embodiment, the systems and methods described herein allow for the following exemplary sequence of agro-industrial processing steps:
1) Cocoa harvesting—Traditional Technology
2) Cocoa beans fermentation—Traditional Technology
3) Cocoa beans drying, bagging & storage—Traditional Technology
4) Fermented & Dried (F&D) cocoa beans' industrial intake—Traditional Technology.
5) Cocoa beans dry cleaning—Traditional Technology.
6) Cocoa beans wet cleaning-modified Existing Technology, new for the traditional or commercial process.
7) Cocoa bean drying-modified Existing Technology, new for the traditional or commercial process.
8) Cocoa bean special roasting in absence of oxygen—New Disclosure equipment & process.
9) Cocoa bean dehulling—modified Existing Technology (done in absence of atmospheric oxygen (air).
10) Cocoa nibs cryogenic pre-milling (coarse)—Modified Equipment (Inlet & Outlet done in absence of atmospheric oxygen (air)). New Disclosure process.
11) Cocoa pre-milled nibs' fat extraction through (LCO₂-based S.C.F.E.)—New Disclosure process, as part of this modified/alternative process equipment; and
12) Chocolate or Compound manufacturing, using Traditional & Alternative process technology & method, the latter, as disclosed in this invention.

According to various aspects of the present disclosure, the wet-milling (through recirculation) may be executed at the end of the homogenization/plasticization stage (and not before dry-conching, as per traditional methods).

In various embodiments, aspects of the present disclosure contemplate the following agro-industrial steps:
1) Steps 1) to 11) from [00250], immediately above, excluding the 12^{th} step (i.e., the chocolate or Compound manufacturing step).
2) The process may follow the other chocolate or compound manufacturing steps discussed herein—Ref. 1.1 (e.g., the unit operations, via equipment sequence #1 to #5, above)
3) Alternative processing methods discussed herein exclude the 6^{th}. unit operation, via use of equipment #6 from the above process (i.e., the use of stripping/distillation & fractionation column), for example, in embodiments where aroma volatiles are not added at the end of the process.
4) Fluid bed agglomeration/instantization/cooling, under semi- or closed-loop, using an inert gas system.
5) Instant cocoa or chocolate powder packaging.
6) In case the end-product is CHOCOLATE IN BARS, several options were disclosed in this invention, and the additional steps include:
   Steps: 1) to 5) from [00250], are traditional technologies.
   Steps 6) to 10) from [00250], are alternative technologies, as disclosed in this patent.
   In addition, the next Steps 11) to 14) are traditional or alternative technologies, disclosed in this patent, and as follows:
   11) Formulation in the Special Ribbon Blender (S.R.B.)
   12) Processing in the Solid Phase Reactor (S.P.R.), done either through Special Conche (S.C.), or Special High-Pressure Extruder (S.H.P.E.)
   13) (Optional) Aroma Recovery
   (14) Cryogenic Ball (Ultrafine) Milling
   15) Storage & (Optional) Aroma Adding-Back
   16) Is traditional technology-Tempering
   Steps 17) to 19) are alternative technologies, as disclosed in this patent, as follows:
   17) Special Dosing in molds 18) Special Crystallization in Tunnel & De-molding
   19) Special Primary Packaging
   Steps 20) to 23) are traditional technologies, as follows:
   20) Secondary Packaging
   21) Automatic Palletizing
   22) Refrigerated Storage
   23) Refrigerated Expedition/Distribution.

Two initial formulas (or composite cocoa products) proposed may include:
Single Cocoa Compound mass with 5-40% (as dark cocoa enhancer only), or Composite, if combined with special additives; and
Composite Cocoa Compound mass with 40-95% (as cocoa dairy cream), if combined with specialty oils & fats (or butters) and special additives).

### Example 4—Dual-Stream Processing with Various Bio-Ingredients (e.g., Tea Bar Processing)

According to various aspects of the present disclosure, the processes discussed herein extend beyond the use of coffee, cocoa beans, nuts, etc.,—to further contemplate processing other bio-ingredients (such as tea leaves) for producing—not only the infusion-type beverages, but solid products, as well, such as food bars. For example, a novel product, presented herein as a “tea-type bar” may be produced via the process briefly sequenced below:
1) Process the bio-ingredients as two separate streams, one as single mass, and the other, as a 2^{nd} Stream, and processed similarly to the process as described in the “Exemplary Dual-Stream Process” in the above section.
2) In various embodiments, at least one of the streams may include flavorings, and the like, including fruits/fruit flavors (such as lemon, peach, orange, etc.), chocolate, coffee, milk and “latte” as additives, etc. for improving flavor variety and agreeability.
3) In one embodiment, the tea leaves, and/or other bio-ingredients' parts: roots, trunks, branches, fruits, flowers, and the like, and suitable for infusion (consumed hot or cold), —or other preparations in form of beverages and/or their dried extracts: may-be fermented (e.g., black tea), under controlled temperature and humidity for achieving an optimal product (based, at least on flavor, texture, aroma, and other attributes); Or may-not be fermented (e.g. green teas).
4) Blend and homogenize the two streams (e.g. for the case of tea leaves' preparation for solid consumption).
5) Follow the same operational sequence, above described in 6) from for chocolates in form of bars, however considering what is specifically applicable for teas.
   Whereas:

The traditional process (e.g. for the case of tea leaves' preparation for consumption as hot infusion drink), consists of:
1) Harvesting.
2) Withering.
   Low quality: “C.T.C.” method (crush, tear, curl).
   Hi quality: orthodox method.
3) Rolling.
4 Roll breaking (green leaf or for shipment).
5) Fermentation (under controlled temp/humidity).
6) Drying (firing)—done with hot air (kiln the fermentation process).
7) Sorting (grading)—consisting in classify and separate whole leaves, brokens, fannings and dust); and
8) Packing and marking for sale or shipment, as dried leaves for tea preparations.

### Example 5—Exemplary Processing with Alternative Natural Oils

In various embodiments, oils from various other bio-ingredients, such as avocados, almonds, and hazelnuts, and/or processed foods, such as dairy ingredients, may be added to processed (or pre-processed) coffee or cocoa for reducing off-flavors, and/or to impart composite flavors.

In particular embodiments, the oils may be derived from fruits or nuts, and the oils may be natural (if so desired) or R.B.D. (refined, bleached, and deodorized), to avoid the introduction of additional and/or rare off-flavors.

In various embodiments, fruit and nut-derived oils are more expensive than typical oils (e.g., sesame oils), and thus, they are generally not used for coffee or cocoa (compounds) processing.

However, given seed oil's characteristics for synergistically interacting with coffee or cocoa and amplifying off-flavors, aspects of the present disclosure contemplate reducing (or avoiding) these off-flavors, via implementing the use of oils derived from fruit and/or nuts.

In a particular embodiment, processing the oils for use in coffee or cocoa may include pre-selecting the roasted beans to be milled, thus eliminating the substandard particles and beans, and the process may be based on ultra-milled coffee mass or cocoa liquor, obtained under cryogenic conditions, thus allowing for optimal use of the product in beverages.

### Other Coffee & Coffee-Like Products—Exemplary Use & Case Scenarios:

Product to be sold as a brew coffee ‘gourmet’ enhancer, ready to use (i.e., as concentrated liquid) and readily soluble/dispersible.

The product could be used in commercial preparation of hot coffees, hot chocolates, or even hot teas—primarily in place of the coffee enhancer and dairy cream, both as non-dairy and dairy cream substitutes.

The two initial proposed formulas could be:
Coffee's single mass—20 to 40% (coffee enhancer only)+special additives (such as fats and/or oils).
Coffee's composite mass, i.e., added with butter oil (coffee dairy cream)+special additives (such as fats and/or oils).

The instant liquid formulas could be adapted to be suitable also as for cold brew (serving) option.

Equipment for manufacturing may include:
Line to prepare single coffee mass (from roasted coffee, as per the already disclosed method & process).
Cryogenic milling equipment.
Secondary package line: product to be packaged in buckets.
Product to be shipped to a co-packer for filling out in cream-type individual or jar type dosing pet packages with removable aluminum seal-no pasteurization required-no cool storage required.
Alternatively, packaging may be completed in-house.

### Example 6—Exemplary Alternative Coffee (Whole or Partial, Single or Composite) Mass

### Manufacturing Process:

Processing steps: (1) Reception of the ingredients (oils, fats, green coffee) and storage; (2) Green coffee dry- and wet-cleaning/drying and storage; (3) Green coffee roasting under inert/noble gas(es) atmosphere; (4) Roasted coffee dry-milling (50-120 microns) under inert/noble gas(es) atmosphere; (5) Melting and storage of the cocoa butter (under inert/noble gas(es) atmosphere); (6) Weighing an transfer of ingredients to a ribbon or sigma mixer (operating under inert/noble gas(es) atmosphere); (7) Mixing for 1-30 min/addition of optional (other) ingredients; (8) Micro wet-milling under cryogenic conditions of the coffee mass to 10-30 microns (preferred under 20 microns), using horizontal or vertical cryogenic ball mill; (9) (Optional) special conching (operating under inert/noble gas(es) atmosphere); (10) (Optional) blending with other conched, refined ingredients (operating under inert/noble gas(es) atmosphere); (11) Tempering; (12) Molding or optional chips dosing, (operating under inert/noble gas(es) atmosphere); (13) Cooling tunnel pre-crystallization (operating under inert/noble gas(es) atmosphere); (14) Product de-molding (operating under inert/noble gas(es) atmosphere); (15) special Primary Packaging (operating under inert/noble gas(es) atmosphere); (16) secondary packaging; (17) Cool Storage and post-crystallization; and (18) Refrigerated Expedition & Distribution.

OTHER COFFEE EXAMPLES—Exemplary Coffee Product(s) Case Scenarios: Product used as a solid single coffee mass, molded in form of bars, chips, morsels, chunks, and the like. Product utilized alone or as a functional ingredient in commercial preparation of hot or cold coffee-primarily as a black coffee enhancer, or in food applications,—when combined with bakery, ice-creams, cookies & crackers, frozen or refrigerated desserts, pies and tarts, and the like.

The instant liquid formulas (R.T.D., or Ready-To-Drink type) could be adapted, and suitable to use as hot or cold coffee (serving) option.

Exemplary equipment may include:
Line to prepare Single Coffee mass (from R&G coffee).
Cryogenic milling equipment.
Direct dosing and/or molding and tempering line; and
Secondary package line.
The coffee mass, now in solid form may be shipped to a co-packer for filling out in cream-type individual or jar type dosing pet packages with removable aluminum seal—no pasteurization required—no cool storage required, or in-house packaging.

Alternatively, if formulated with other bio-ingredients, the product may be shipped as a “B-to-B” (or business-to-business) arrangement, where other food and beverage lines of products will utilize the product (after melting) as a functional ingredient to their final products.

### Example 7—Exemplary Aroma Capture, Add-Back, and Controlled Release

In various embodiments, aromas from the bio-ingredients (e.g., roasted coffee) may be captured and implemented for fragrance purposes.

In particular embodiments, the coffee aromas may be captured via cosmetic preparation techniques to create a perfume (or similar compound) including various chemical functional groups such as (but not limited to): aldehydes, esters, alcohols, ketones, lactone, ethers, nitriles, etc.

According to various embodiments, the bio-ingredients may be blended with various natural and/or synthetic raw materials for creating a stable and controllable fragrance compound.

In certain embodiments, to increase the efficacy of any fragrance or flavoring, controlled release of the volatiles in implemented.

In one embodiment, active volatiles are released to the atmosphere at a desired place, time, and rate. This may be influenced by heat, temperature, pH-sensitive ingredients, etc.

In particular embodiments, the controlled release of the volatiles may be: (1) delayed; (2) sustained (prolonged); and (3) “burst-released”.

According to various aspects of the present disclosure, controlled lease of volatiles is achieved via encapsulation/micro-encapsulation, coacervation, co-crystallization, molecular inclusion, adsorption, etc.

Consequently, the controlled-release mechanisms involve diffusion-controlled release, osmotic-controlled release, swelling-controlling release, solvent-activated controlled release, or moisture-triggered controlled release.

In various embodiments, the controlled release of the aromas may be initiated by pressure, melting, pH changes, or changes in temperature.

According to various aspects of the present disclosure, these active volatiles may be captured and stored within a material such as a rigid or flexible pad, natural and/or artificial flavoring (i.e., in solid, liquid, or gas form).

In particular embodiments, these pads, flavors, or other materials may be included within the layers of particular packaging (e.g., within composite packaging laminates).

In one embodiment, the packaging may include bags, boxes, or other forms of secondary and/or tertiary packages, and the packaging materials may be porous or semi-permeable to allow the active volatiles to release through the packaging layers,—whereas the product content is completely protected against atmospheric oxygen (air).

In some embodiments, the active volatiles may be included on the exterior layer of the packaging, or the active volatiles may be included in a location proximate to one or more units of packaging to provide an area with the aroma. As such, the aroma provided by the active volatiles may influence human behavior (e.g., a consumer may purchase coffee beans in response to smelling the aroma provided by the active volatiles).

### Example 8—Process for Reduction the Residual Moisture in Coffee Beans

One of the most challenging aspects of coffee mass manufacturing and preservation can be the elimination of residual moisture of the roasted coffee without the concourse of special conching step, because the latter would negatively affect the natural coffee flavor's intensity and quality of the process.

Because of the required application of both quenching and cooling unit operations (respectively to interrupt the thermolysis, followed by its stabilization), roasted coffee may contain up to 5% of entrapped moisture (having a min. of around 1.1%). This may present a limitation for the utilization of this functional ingredient in the formulation of coffee bars and other coffee-related finished products in solid- or liquid presentation.

In various embodiments, any residual moisture in the finished product beyond approximately 1.25% is capable of significantly increasing the viscosity of the coffee mass, thus creating a hurdle for the molding process due to difficulties for proper dosing and properly filling the coffee mass into molds.

Discussed below is an alternative process for eliminating the coffee residual moisture without affecting the quality and intensity of the coffee flavor/aroma.

In various embodiments, aspects of the present disclosure may allow for finished coffee products of lower viscosity and full natural coffee flavor/aroma, compared to what is already true for some chocolate products.

In one embodiment, the process may include the following steps:
1) Coffee roasting in the absence of oxygen (air) and/or under inert/noble gas presence.
2) Dry milling the coffee into a convenient particle size done in absence of oxygen, and under controlled low temperature, preferably under cryogenic conditions.
3) Freeze-drying the roasted & ground coffee under cryogenic conditions of −45° C. (minus) to −190° C. (minus), followed by high vacuum (−720 Torr) processing conditions and from 1 to 36 hrs. of total processing time, during which the coffee particles will be progressively heated until <(less than) −20° C. is reached, to facilitate sublimation of the component water.
4) The process may be either batch or continuous.
5) In the continuous process solution, the freeze-drying chamber may be connected to a cryogenic condenser, to recover the aromas in water solution, which would be followed by an aroma recovery column equipped with a secondary cryogenic condenser. The concentrated coffee aroma may then be then added back at the end of the production process.
6) The (dehydrated) coffee may then follow the single coffee mass production processes discussed herein until the mass is ready and stored, and thus waiting to be proportionally blended to the coffee-less conched and refined product, so that to compound the coffee mass will be ready for tempering, dosing, molding, demolding, and packaged as finished product.
7) Table 1-Presents a summary of this novel Roaster concept, part of this patent invention and basic details of the design of the invention, encompassing all proposed variations of its features. The variations encompasses the following basic conceptual design & assembly characteristics & features: (1) Operating version; (2) Configuration; (3) Quenching & Torrefacto Systems; (4) Heat Source Location; (5) Design capacity; (6) Type of Operation; (7) Heat Source/Type; (8) Construction materials; (9) Heating method; (10) Operation mode; (11) Load/Discharge Systems; (12) Heat Source Conduit; (13) Rotary Control Mechanism & System; (14) to (16) Inlet Gas Pipe, Valves & Controls; (17) quenching and/or “torrefacto” location; (18) Mechanical Device for Kinetic Effect; (19) Manual/Automatic Sample Supply Device & System; and (20) Other Roaster Apparatus Features, Characteristics, Devices and Other Gadgets, not otherwise listed.

FIG. 7—Presents a simplified Block Flow Diagram (B.F.D.) of the roasting processing phase of bio-ingredients and/or foods or beverage products, where it is sketched two of the several variants of the invention, being one a rotary drum roaster type, and the other, a listed idea of a continuous roaster type. Both versions are based on a novel concept of roasting, carried out under vacuum, under partial- or total atmosphere-compensated, or under inert/noble gas(es) pressurized apparatuses. The basic concept is an entire new class of roaster machinery, where the commonality is its design and processing operation in absence of atmospheric oxygen (air).

These proposed novel roasters' apparatuses variants are built to operate completely hermetic, in a closed- or semi-closed loop configuration, as also illustrated under—Ref. 1
“Modus-Operandi” (or Ambiental Processing Conditions): The basic concept and design of the novel roaster proposed is fundamentally based on their design, construction and operation focus on in the absence of atmospheric oxygen (air), i.e., having as key variants of the environment conditions they operate, as follows:
   Under Vacuum of <760 Torr (less than) to <0.001 Torr (less than) (Ref. A); and/or
   Under Compensated atmosphere with any noble gas(es), such as Helium (He), Argonium (Ar), and the like),—and/or any inert gas(es), such as Nitrogen (N₂), Carbon Dioxide (CO₂), Super-Heated Steam (S.H.S.), etc., (Ref. B)—provided they are authorized for use in the food industry, through means of direct- and/or indirect contact, during processing, with bio-ingredients and food- or drinkable-convertible foods.
   Under Pressure, with pressure from >1.0 (more than) Kg/sq.cm and up to 20 Kg/sq.cm., and by using any heated & pressurized gas (such as any inert/noble gas(es) (Ref. C))
   in such cases, also equipped and configured with internal- or external inert gas recovering system, in closed-(Ref. D), (to minimize gas(es) losses) or semi-closed loop (Ref. E)
   Equipped with a Quenching and/or a Torrefacto Device Applicator System, which can be installed internally (Ref. F), or externally to the apparatus (Ref. G)
Novel Roaster Apparatus' Variants: The proposed Special Roasting Apparatus (based on the Concept and Design above), encompass certain sub-variants, concerning:
Location of the heat sources: They are either placed internally (or built-in), (Ref. H), or externally to the roaster (Ref. I).
Design Capacity: from small size for bench/Lab. operations (minimum of 0.1 Kg of load) (Ref. J), Pilot-Plant (Ref. K) to large industrial size of e.g. around 20,000 Kg/load (Ref L).
Operational Condition or Type of Operation: Batch- (Ref. M), Semi- (Ref. N), or Continuous Operation (Ref O).
The Method of Heating Transfer sources to the drum (or processing compartment) utilized:
   Any suitable gas, liquid or solid fuels as firing/heating source (REF P),—however in such cases, only for indirect contact with the bio-ingredients/derivative products being processed; and/or
   Electric heating (Ref Q), and/or
   By means of using non-ionized electromagnetic waves as source, from the I.R. (infra-red (Ref. R), to visible radiation (Ref. S), to microwaves (Ref. T), to the radio-waves (Ref. U) of the wavelength spectrum, and/or with frequencies from 3 PHz to 3 Hz, and wavelengths from 100 nm to 100 Mm.
   S.H.S. (Superheated Steam) (Ref W); and/or
   Any other suitable pressurized/heated inert and/or noble gas(es) (REF X)

For this latter alternative, the utilization of electromagnetic waves, such as R.F. (i.e., radio frequency) or microwaves (i.e., M.W.) for heating and/or roasting, which provides a more efficient and uniform way to the heating and/or roasting process desired.

The Materials employed for the construction of the processing drum (or compartment), and in direct contact with the bio-ingredients being roasted: Any type of metal (Ref. Y) or alloy allowable (Ref. Z) for processing food-grade and/or Drinkable-convertible-grade products; and/or,

The Heat mode of utilization in the Apparatuses: direct-(Ref. AA) or indirect (Ref. BB) contact with the bio-ingredients being roasted.

The specific utilization of all variations of the proposed Apparatuses: Applicable for the special roasting of the bio-ingredients listed along this Patent Application, which will be designed to operate Manual (Ref. CC), Semi-Automatic (Ref. DD), or Fully Automatic (Ref. EE).

The proposed apparatuses have a load & discharge cyclones (Ref. FF), smoothly connected respectively to, the feeding system of the bio-ingredients into the sealed rotary, stationary or roasting drum or bean containment, thus allowing the roasting of the bio-ingredients in the absence of atmospheric oxygen (air). And to the discharge system-both capable of maintaining a hermetic, locked inert environment, absent from atmospheric oxygen (air).

A heat source conduit system (Ref. GG), for allowing heating the roasting drum (or the processing compartment).

In the case of the rotary drum (or processing compartment), a rotation control mechanism & system (Ref. HH), for controlling the rotation of the roasting drum (or processing compartment).

An inert gas inlet pipe, valves & controls (Ref. II), to allow a smooth connection to the roasting drum (or processing compartment) for providing flashing-off of eventual atmospheric air entered into the roasting drum (or processing compartment); An inert gas outlet pipe, valves & controls (Ref JJ), to allow smooth connection out of the roasting drum (or processing compartment), for a recovering gas system.

An inert gas inlet pipe, valves & controls (Ref. KK), to allow a smooth connection to the roasting drum (or processing compartment) for eventual distribution of pre-heated inert gas(es) to be utilized in the roasting process, and a corresponding heat pump system, to allow indirect heat exchange between heating and cooling gas(es),—thus securing an economic, optimized heat transmission into the roasting chamber (drum or processing compartment) process.

A quenching system (retractable or not) (Ref LL), with a smooth connection, either connected to the roaster, or, alternatively, to the first stage of the F.B.D.&/orC. in the roaster option, it is connected into the roasting drum (or processing compartment), and consisting of pipes, valves, spraying nozzles and controls, and capable of resisting the roasting temperatures of the process, and to effectively able to deliver the dual task of: (1) quench the thermolysis reactions by means of water or food-grade organic solutions; and (2) allow to apply the “torrefacto” effect, by spraying the bio-ingredient(s) under roasting, with a layer of edible organic solution.

Equipped with a mechanical device(s), able to promote a kinetic effect (Ref. MM), to the bio-ingredients being processed, such as vibration, rotation, tumbling, mixing, churning, fluid-bed suspension, and the like,—to facilitate the heating transfer process, in a batch-type or continuous apparatus' operation.

Equipped with a device that allows for automatic sampling (Ref. NN) at any time of the roasting processing taking place; and/or with other typical features,—common to all traditional roasters.

In Reference to the Baking-Goods' bio-ingredients & products, their processing equipment, alternative processing technology and adopted methods:

For the reasons already—and extensively discussed (concerning the Factors related to shortening of shelf-life and food quality Deterioration & Rancidification), and in addition, to the probable motives,—the inventor established, for the first time, the especially modified and specifically adapted Vacuum, atmospheric-compensated, or pressure Oven apparatuses, with- or without inert- and/or noble gas(es)—atmosphere compensated, and operating at N.A.P.E., under-, or over-pressurized processing conditions, and having this type of modified machinery for the exclusive (or specific) use for bake processing of all types of Baked Goods.

The Invention's Adopted Assumptions, Criteria & Alternative Equipment & Processing technology:

Basic criteria: for the alternative process technology is disclosed that all unit operations carried out in the manufacturing of baked-based ingredients & products, to be carried out in absence of atmospheric oxygen (air),—with- or without inert- and/or noble gas(es) compensated atmosphere, operating at N.A.P.E., and under- or over-pressurized conditions. As such, all the equipment involved in their processes should be properly modified and specifically adapted to operate under such disclosed food-based processing conditions.

### Examples of Application of this Invention

Example 1—For Breads Manufacturing. Following the pertinent discloses of the Inventor's original P.P.A., i.e., adapted for the reality of the baked-based bio-ingredients and processed products, and assuming an operation e.g., under high to low vacuum (e.g. ca. 23.0 Torr), the following basic processing steps & parameters shall be utilized-all in absence of the atmospheric oxygen (air), with- or without compensated inert- and/or noble gas(es) atmosphere, and operating at N.A.P.E., under- or over-pressurized conditions. In this example for Bread Loaf production, here-below are the basic unit operations, under this Invention's guidelines: Reception of raw materials (Grain Silos)—dry cleaning+wet cleaning in cool water, as disclosed in the original P.P.A. This option requires all the Cereals' milling processing to be carried out in absence of atmospheric oxygen (air).

Notice that, as there are no existing special Millers with such above-mentioned processing capacities, the inventor believes that a more realistic approach for the present industrial condition would be to simply use the traditionally processed wheat flour,—however, to be aware that, by adopting this practical solution, in fact it somehow reduces the full potential for the Baked Goods, in reaching their full, (or expected) extended shelf-life,—as well as their maintenance of perceived quality. Saying that, it was determined in the two cases tested for roasted-based foods, that the negative impact of not adopting the procedure for raw materials' initial cleaning & pre-conditioning (as recommended in this Invention),—it should be expected an estimated between 10-20% reduction in the expected/extended shelf-life's potential for the baking-based products.

Dough Preparation/Mixing/Handling/Resting/Final Proofing/Decoration/Molding/Depositing—All these steps requiring specially-modified equipment, specifically adapted to process the dough, and done in absence of atmospheric oxygen (air).

Special Vacuum Oven (S.V.O.): in this example, it was assumed a particular model of continuous (S.V.O.), heated through microwaves, and therefore dispensing the need to use inert- and/or noble gas(es)—except in the 5^{th}. Compartment for Pre-Cooling.

In this case, one of the disclosed variants, an especially-adapted (S.V.O.) machinery, its exemplar layout may be composed of—for example, five compartments, all operating in absence of the atmospheric oxygen (air), as follows:
1^{st}. compartment: Load-in the pre-conditioned dough into pans
2^{nd}. Compartment: Pre-Heating & Baking section (Oven Spring stage)
3^{rd}. Compartment: Heating (designed for 2^{nd}. Phase) (Oven Rising-Initial stage)
4^{th}. Compartment: Heating (designed for 3rd. Phase) (Oven Rising-Final stage)
5^{th}. Compartment: Pre-Cooling of the Bread Loaves

Baking Processing Operation of the (S.V.O.), as above exemplified:
1^{st}. Phase (or Oven Spring): e.g., oven temperature initially adjusted to ca. 50° C. for 5-7 min.
   Dough receives a mild steam injection at low temperature (2-5 psi) for 1-2 minutes
2^{nd}. & 3^{rd}. Phase (or Oven Rise): oven temperature adjusted and maintained at 220-238° C. for the remaining of the baking time (ca. 10-11 min.).
Bake Finishing: (occurring in the 4th Compartment): the oven shall be kept at 220-238° C. for few minutes, to firm-up the desired crust color.

Pre-Cooling Process—Carried out under vacuum-compensated pressure, with inert(s) and/or noble(s) gas(es), using a suitable combination of time & temperature, where the loaves are removed from the pans and travel through the pre-cooling conveyor at a determined pre-adjusted speed, receiving a counter-current flow of the pre-cooled gas(es) at a suitable temperature, compatible with the residence time required to lower the temperature below the critical Loaf temperature,—otherwise the thermolysis will continue to progress, and further darkening the loaves.

Cooling Process—The Pre-Cooled stages are carried out outside the special Vacuum Oven into a subsequent multi-band-type cooling tunnel apparatus,—also operating under vacuum-compensated pressure, using inert(s) and/or noble(s) gas(es)′ conditioning, blowing in counter-current flow to the movement of the Loaves, and able to cool down the loaves to a max. of 35-40° C., and using incondensable, inert/and or noble gas(es) at atmospheric-compensated conditions. This, or any other suitable cooling method could be utilized, such as:
M.A. (Modified Atmosphere) Convection Cooling: This method normally takes more than 2 hrs. to be completed, and while it is the cheapest way to do it, nevertheless it demands extra industrial space, and/or extra conveyor network.
Cooled M.A. Conditioning: Based on the right combination of suitable Wet- and Dry-bulb temperatures, with the inert and/or noble gases, pre-cooled at 22-25.5° C., and adequate internal R.H. and ratio Gas(es) to Loaves' speed determines the end of the process, when product should have its center temperature at around 32° C. Normally, this modified process takes less than 1 hr. to be completed.
Vacuum Cooling: The most efficient system and can be completed in 15-30 minutes.

Freezing—Optional (depending on the specific business).

Slicing Station—under same previous processing conditions.

Packaging Station/Handling—Place where the product is packed using M.A.P. (Modified Atmosphere Packaging) technique, and suitable packaging materials, designed to jointly ensure the best potential for quality & shelf-life's preservation conditions.

### Storage & Distribution.

Example 2—For Pies Manufacturing,—all processing steps shall be mandatorily conducted under vacuum and/or vacuum compensated with inert/noble gas(es) (under- or over-pressurized) conditions, which indicated that-depending on the vacuum, and for the same processing time, the temperatures can be about ⅔ of the processing temperatures below disclosed:

Pies manufacturing comprises eight steps, as follows:
1) Dough Preparation:
   Mixing Ingredients.
   Kneading & resting the dough for gluten development.
   Division the dough into desired portions.
2) Sheeting & Forming:
   This operation is conducted using sheeters or rolling pins.
   Circle or Square cutting for the pie base.
   Placement of the base pie in pie thins or molds.
3) Filling:
   Filling formulation/preparation.
   Filling dosing (several types) to the pie base.
   Ensuring consistent portioning and spread.
4) Covering (Closing) or Lidding:
   Place the top layer of dough over the filling (or “lid”).
   Sealing of the pie edges by crimping or pressing.
   Optional: Creation of decorative patterns at the lid.
5) Vacuum Oven Baking (or Vacuum with Gas(es) Compensated (under- or over-pressurized Gas(es) Oven):
   Pies are placed on baking trays or indent plates.
   If the Vacuum oven is heated by for example microwave or RF, there is no need in the operation to use inert(s) gas(es) and/or noble gas(es).
   In cases of forced convention and/or impingement, the gas(es) are required, and operate at slight to moderate under pressure.
   Bake at variable temperatures of 175-218° C. and for a variable time 5-30 min., depending on the type and size of the pies being processed. If meat types, and depending on the size, temperature should be around 175° C. for 25-30 min. For fruit pies, it would be recommended we initiate the baking process at higher temperatures, i.e., ca. 218° C. for the initial 20 min. and subsequently reduce it to ca. 190° C., to prevent sogginess.
   For safety reasons, the center of the pie shall reach no less than 60-65° C., and center temperatures above 70-80° C. promote gradual-to rapid loss of moisture, affecting the perceived product quality & shelf-life.
   Final Stage: When the pie acquires a golden-brown crust color, it indicates the end of the process.
6) Cooling & Glazing:
   Pies are cooling anywhere from 1-2 hrs. before glazing and/or packaging. In the P.P.A. (extended), because this is done under vacuum or vacuum compensated and assisted by forced gas(es) convection, the process may be reduced to around ½ hr.
   Optional: Glazing with sugar, egg wash, or syrup.
   Inspection/QC (1): done for uniformity, taste & Appearance & Removal of any defective pies.
7) M.A.P. Packaging & Labelling: in special/suitable packages, distinct from the traditional boxes, trays, and the like.
8) Final Inspection/QC (2): packaged foods-visual presentation, absence of label/physical damages/removal of any defective packages.

Example 3—For Biscuits: (Cookies & Crackers) Manufacturing,—all processing steps shall be mandatorily conducted under vacuum and/or vacuum compensated with gas(es) (under- or over-pressurized) conditions, which indicated that,—depending on the vacuum, and for the same processing time, the temperatures can be about two-thirds of the processing temperatures below disclosed:

### Example 3.1—Cookies

Ingredients Reception & Storage.
Ingredients Selection & Intake.
High-speed Mixing Machine: variable time & reaching of consistent, uniform dough with a max. of 15% moisture (if molded), or (up to 40%, if wire-cut)—where methods chosen will impact on dough and final cookie quality. The final dough temperature should be around 40-42° C.
Forming: It is done using molded or wire-cut machines
Vacuum Oven Baking (or Vacuum with inert(s) and or noble Gas(es)—Compensated under N.A.P.E, under- or over-pressurized Gas(es) Oven):
   Oven pre-heated: to 175-180° C.
   Baking time: 13-15 minutes.
   Pre-cooling: min of five (5) minutes, (under vacuum and forced convection using counter-current gas(es) flow, to take them out of the over-baking temperature zone, due to the presence of sugar in the formula and the relatively low residual moisture in the hot cookies.
Cooling: using ratio of 1.5 baking time: 1.0 cooling time, or around 20-24 min.
M.A.P. Packaging.

Example 3.2—Crackers:
Ingredients Reception & Storage
Ingredients Selection & Intake
Mixing Machine: variable time & reaching of consistent, uniform dough with around 15% moisture to the next unit operation works properly. The final dough temperature should be around 40-42° C.
Forming:
   Laminated; or
   Sheeted without lamination
Vacuum Oven with- or without inert- and/or noble gas(es) atmospheric-compensated (operating at N.A.P.E., under- or over inert- and/or noble gas(es) pressurized processing conditions—and using 4 distinct temperature zones, as follows:
Zone 1:300° C.
Zone 2:290° C.
Zone 3:280° C.
Zone 4:260-250° C.
Baking time: 2-4 minutes/Zone=Total baking time of 8-16 min.
Pre-Cooling: min of five (5) minutes, (under vacuum, and forced convection using counter-current gas(es) flow, to take them out of the over-baking temperature zone, due to the presence of sugar in the formula and the relatively low residual moisture in the hot cookies.
Cooling ratio: 1.5 baking time: 1.0 cooling time, or around 16-32 min.
M.A.P. Packaging.
   G.2.2—Differential Inventive Aspects of this Extended P.P.A. Concerning Machinery for Baked Goods Application:

Uniqueness/Novelty: For the specific disclosures of the P.P.A., they were required to be modified for, specifically:
Specific Process operating conditions: carried out entirely under vacuum processing conditions and/or of vacuum- or gas(es)' atmosphere-compensated (operating at N.A.P.E., under-, or over-gas(es) pressured conditions, as disclosed.
Required Adaptations/Modifications for All Machinery's Loaded-ins & loaded-outs: This requirement is a must and applicable to process all types of Baked-Goods, and Valid for the bio-ingredients, the in-process products, and the finished products, which should be carried out—all time—under processing conditions of vacuum and/or vacuum gas(es) compensated (operating at N.A.P.E., under-, or over-gas(es) pressurized conditions.
Processing Specific Capabilities & Parameters adaptations: Required for all the Machinery employed in this Invention disclosure by my P.P.A.,—especially for the main unit operation in the Baked Goods' segment of the Food & Beverages Industries, —represented by the Vacuum Ovens and Vacuum inert- and/or noble gas(es) atmospheric-compensated (operating at N.A.P.E., under- or over inert- and/or noble gas(es) pressurized conditions) Oven-whose equipment, in this P.P.A., also represents the Novel part of the Machinery's specific utilization for Baked Goods manufacturing, and part of this Invention disclosure.
8) G.2.3—Other Specific Machinery's Requirements of the Patent Application: Table 2—Presents a summary of this novel Oven concept, part of this patent invention and basic details of the design of the invention, encompassing all proposed variations of its features. The variations encompasses the following basic conceptual design & assembly characteristics & features: (1) Operating version; (2) Configuration; (3) Quenching & Torrefacto Systems; (4) Heat Source Location; (5) Design capacity; (6) Type of Operation; (7) Heat Source/Type; (8) Construction materials; (9) Heating method; (10) Operation mode; (11) Load/Discharge Systems; (12) Heat Source Conduit; (13) Rotary Control Mechanism & System; (14) to (16) Inlet Gas Pipe, Valves & Controls; (17) quenching and/or “torrefacto” location; (18) Mechanical Device for Kinetic Effect; (19) Manual/Automatic Sample Supply Device & System; and (20) Other Oven Apparatus Features, Characteristics, Devices and Other Gadgets, not otherwise listed.

Depending on the Specific type of Baked Goods to be manufactured, the fabrication of the continuous Vacuum-, Vacuum compensated, or Pressurized Oven should be equipped with up to 7 (seven) interconnected compartments, as follows:
1 compartment of feeding and placing in molds, pans or the lake.
4 compartments of differentiated times & temperatures processing parameters.
1 compartment of pre-cooling.
1 compartment of load-out/unpanning.

Moisture Control with alarm.

Built-in Automatic Products' Recipes Programs.

Complete Built-in or External Vacuum- or Pressurized System, capable of operating from slightly higher pressure to low or medium vacuum (i.e., from ca. 1.1 Kg/cm² to 0.001 Kg/cm²).

Complete built-in or external inert(s)- and/or noble gas(es) system.

Heating Sources, as previously disclosed, direct- or indirect.

Impingement capability: direct- or indirect, based on the pressurized re-circulation of the heated inert(s) and/or noble gas(es), to shorter processing times, and/or special products.

Other features, as previously disclosed under both the original and extended P.P.A. disclosed Types, Sizes, Capacities & Other Features for the conveyors (if continuous) or interior & shelves (if batch).

Loading & Unloading transfer conveyors under air-absent, confined environment.

Jet of gas(es) and/or hydro band coolers.

High power, allowing for rapid- and increased heat-up performance, with Energy & Gas Recovery/Recycling Systems in place.

Built-in or External Pre-Cooling System.

Automatic dough panning and loading-in the process conveyor (for continuous-models).

Models with single- or multi-layers conveying.

Sanitary, robust, sturdy and safe construction, semi- or closed loop operation, suitable for vacuum-, vacuum-compensated, or pressurized food operations.

Equipped with manual- or automatic, programmable steam injection system.

Minimization of heat & gas(es) losses, with automatic gas re-circulation system, automatic replenishment of gas, leaking gas alarm, built-in recovery gas system, and variable frequency drive, for the process controlling time, via gas re-circulation blower for variable speed, with automatic gas temperature control.

Inert gas(es) and/or Noble Gas(es) Purge System.

Low/Leak Inert gas(es) and/or Noble Gas(es) Alarm System.

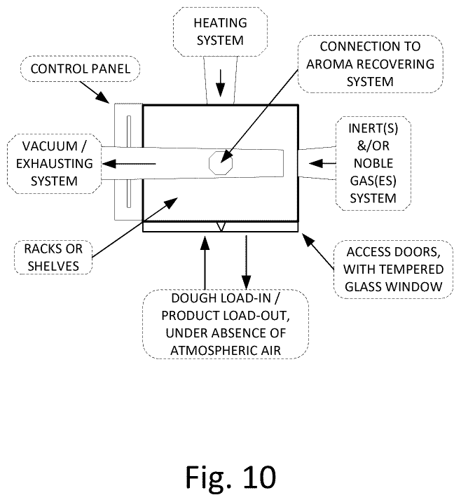

For Batch-type Models: Simplified Layout as sketched in FIG. 10

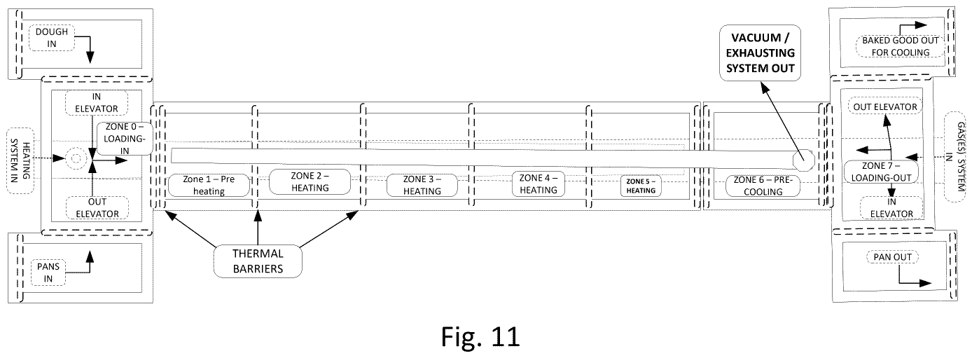

For Continuous-type Models: Simplified Layout as sketched in FIG. 11

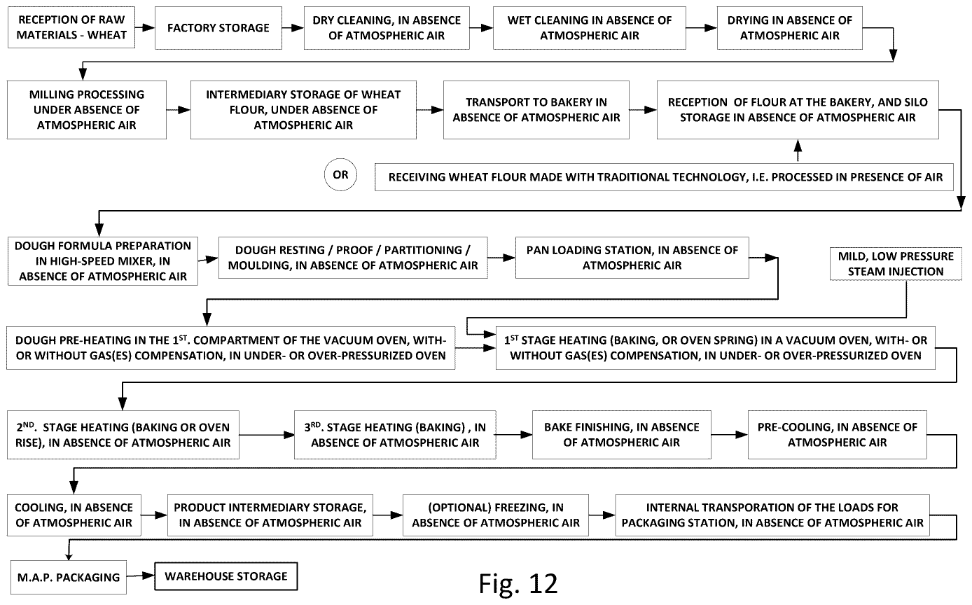

Applicable for all Baked Goods oven-processing (e.g. Bread Loaf), sketched in FIG. 12

Automatic Exhaust system.

Built-in connection for optional/potential capability for an external link to an aroma-recovering system

Built-in after-burning system to allow filter and/or elimination of off-gas residues from the process.

Advanced Layout & Modular Design, allowing bakery process flexibility, through modular design and programmable controls & controllers, auto-recipe capability, allowing total process control & for intelligent baking of a variety of food products, data logging & trending capabilities, multi-points thermal monitoring system for better control of quality & safety of the in-process products.

Automatic Flowing-in/Shutting-off gas inflow.

Automated, programmable steam injection.

Quenching/“Torrefacto” capability.

Trace/Residual Oxygen Safety Monitor, Detectors & Alarms.

For the continuous models, the possibility of utilizing several types of conveyors, such as made of wire-mesh, stones, steel band, and the like-provided they are sanitary & approved for direct contact of foods, with inter-cooling capabilities.

Built-in or external automatic and flexible load-in station of the products in straps, pans, trays, molds, and the like.

Versatile & Flexibility for processing a large variety of baked goods.

Capability for quick changeovers.

Built partially pre-assembled & modular, to reduce installation times.

Individual adjustments for each baking zones/compartments (modules or stations).

Toolless cleaning & sanitation: to make more flexible multiple changeovers.

No-direct contact possible: between the combustion gases with the food products.

This list in no way intends to be conclusive. Because the Invention disclosed by nature is Novel, it may identify other features and therefore required to be adopted to perfection the Invention.

G.2.4—Additional (or Extra) Main Features, Materials, and Manufacturing Details.

For the majority (and common) sequence of unit-operations disclosed. It is then necessary to disclose the basic modifications, inclusions and/or adaptations required for convert Vacuum, Vacuum-Compensated and/or Pressurized Ovens of distinct sizes utilized for baking foods of type “Baked-Goods”, and features for the suitability of this Invention application to all potential baked-based bio-ingredients and their derivative processed products.

Therefore, and further to the already disclosed features required by the Vacuum Ovens, Vacuum inert- and/or noble gas(es) atmospheric-compensated, and/or Pressurized ovens (i.e., operating at N.A.P.E., under- or over inert- and/or noble gas(es) pressurized conditions processing operations' type Oven, and in accordance with this disclosed Invention, this Oven equipment should be built, having the following basic, extra, and/or additional recommended features:
Temperature Range, Control & Deviation: from A.T. to 450° C.
Redundant Over- and Under Temperature Control.
Redundant Over- and Under Vacuum Control.
Monitors for flammable gases accumulation (in cases of gas-fired option).
Automatic Greasing equipment for movable parts (e.g. plates, conveyor).
Retractors in between the sections and both before- and after the oven system.
Uniquely and easily accessible doors, with electro-mechanical or pneumatic door locks, for suitable operation, cleaning & maintenance.
High standard insulation & shattered-proof tempered, adequate for high-pressure- & sudden depression safety visual glass doors for easy process inspection under high-temperatures, and to variable pressures, with built-in alarms system.
Efficient energy utilization.
Automatic dumper system that allows for balanced distribution of the gas(es) circulation and/or exiting, with no active gas waste to atmosphere, with automatic fan control.
Trace solvents Safety Monitor, Detectors & Alarms.
Emergency power-off push-bottom & Emergency stop.
Equipped with Main Power fuse, bi-metal & digital (circuit-breaker) over-current detection-based disconnectors/shut-off redundant systems.
Redundant over-temperature, under- and over-pressure & timer disconnecting switches.
Equipped with 3-color Light tower-type assembly and audible alarms.
Safety Circuit Breaker lock-out for maintenance services.
Conveyor Drive: shall be built using geared motor, with variable speed, and automatic tracking system, equipped with automatic self-alignment belt.
Modular design, with flexibility to be accommodated in various factories' layouts.
Inspection doors with built-in internal and/or external light(s) for in-process inspections.
Built-in or external interconnection with automatic recipe management system, allowing interconnection with Ethernet & USB communications.
User-Friendly MHI: for easy change of recipes.
High thermal capacity & Precise Process Control, including 24-h, 7-day digital process timer and temperature recorders (both digital & on paper, for facilitating process audits).
Short set-ups and automatic/programmable heat recovery times.
Low/Leak automatic inert/noble gas(es) detector and alarm.
Trace O₂ detector and alarm.
Providing even baking: especially across the belt width.
External & internal options in stainless steel, and alternative finishings.
Option for reverse door hinges.
Min. number of authorizations or Licenses Issued for equipment utilization in Latin America, North America, UE, Australia, New Zealand and in main Asian Countries, such as: Japan, S. Korea, Philippines, India, Malaysia, and Singapore.
This list in no way intends to be conclusive. Because the Invention disclosed by nature is Novel, it may identify other features and therefore required to be adopted to perfection the Invention.

### G.2.5—Specific Functions of the Additional Invented Utility Patent Application:

This Invention's extension to the original P.P.A. submitted was specifically developed to encompass the segment of the Global Food & Beverages Industries represented by the Baked-based processed bio-ingredients and their derivative processed foods,—collectively identified as “Baked Goods.”

Moreover, it discloses a novel system, especially modified and specifically adapted Vacuum Oven, Vacuum-Gas(es) Compensated and/or Pressurized Oven machinery, Alternative Processing Technology & Methods conceptualized and aimed for primarily process Baked Goods, as a class of foods.

The Main Reason for this Invention is to address a key concern of the Food Science, Technology & Engineering that the Inventor identifies as an absolute major drawback for the Baked Goods Segment of the Industry: The Shorten of Quality & Shelf-life of all the representatives of this segment of foods, caused by induction of degradative processes, with significant economic consequences.

These induced degradations are of various origins, such as: Physical, Chemical, Physical-Chemical, Rheological, Biochemical, Enzymatic, and/or Microbial nature,—as well as from other reasons, which may also be a health concern.

Specifically In case of the Baked Goods products, there are products thermically processed at elevated temperatures, still there are various negative impacting factors. However, the major ones are related to: Oxidation and Rancidification. As both degradative processes are assisted by oxygen (gas or active radical) and augmented by high temperature, it sounds obvious their significant importance in the overall—and dramatically reduction of potential quality and shelf-life of these products.

In addition, another important drawback with traditional processing technology is related to health concerns, losses in nutritional value of the Baked Goods, especially as related to losses of Vitamins, certain Nutritional factors, the negative consequences of excessive induction of Maillard reactions, and negative effects in certain proteins and carbohydrates. Note that health concern may be amplified due to large individuals and repetitive habit consumption of baked-goods by the population at large.

Therefore, the Invention tackles directly these negative factors, by changing the traditional technology, and instead, disclosing an alternative and novel system, by the adoption of especially modified & specifically adapted Vacuum Oven and/or Vacuum Gas(es) Compensated, and/or Pressured Oven machinery, an alternative Processing Technology & Methods, aiming at fixing the current and intrinsic problems associated with the traditional processing technology of Baked Goods.

### G.2.6—Additional Baked-Goods Applications:

Could be applicable for the dehydration of heat-sensitive food products, such as specialty Baked-Goods of high sugar content.

To promote controlled- and desirable crystallization at lower temperature of specialty Baked Goods.

To promote commercial sterilization to specialty Baked food products, such as for space and critical nourishing applications and for special formulae required applications.

In maximization and retention content of selected Nutrients, such as in vitamin-enriched Baked-Goods' products & formulas.

Other Baked Goods' specialties.

G.2.7—Specifications & Variant Models of the Additional Invention (Systems, Especially Adapted and/or Modified Equipment, Processing Technologies & Methods:

Concerning the Especially Adapted and/or Modified special Vacuum Ovens (or S.V.O.s), vacuum-compensated (C.V.O), or pressurized ovens (S.P.O.), and using Vacuum inert- and/or noble gas(es), atmospheric gas(es)—compensated,—operating at N.A.P.E., under- or over inert- and/or noble gas(es) pressurized conditions) Ovens (or V.G.C.O.s:

Configurations (Sizes, Capacities, and/or Models):
Bench, with basic capacities from 0.1 to 10 Kg/hr.
Laboratory, with basic capacities from 1 to 25 Kg/hr.
Cabinet, with basic capacities from 10 to 5,000 Kg/hr.
Pilot-Plant, with basic capacities from 10 to 100 Kg/hr.
Industrial, with basic capacities from 50 Kg/h to 10,000 Kg/hr.

### Equipment Processing Lay-Out-Versions or Variations:

Horizontal (Floor- or suspended).
Vertical (Floor- or suspended).
Straight-through walking.
Uni-opening Walk-in.
Straight-through Truck-in.
Uni-opening Truck-in.
Vertical Loaded/unloaded.
Horizontal Loaded/unloaded.

### Levels of Vacuums Utilized in the Equipment:

Low Vacuum: <760 mm Hg/>1.0 Torr
Medium Vacuum: <1 mm Hg/>0.001 Torr
High Vacuum: <0.001 mm Hg/>0.00000001 Torr
Vacuum Compensated at =<760 mm Hg/=>1.0 Torr, using Inert(s), and/or noble(s) gases, typically operating at normal pressure to slightly under pressure.
Variable Internal Pressure: e.g., by using S.H.S. (Super-Heated Steam), employed at various pressures and temperatures.

### Modes of Heat Supplying:

Direct (radiant, radiation).
Indirect (natural convection, and/or forced convection).
Combination of heat supplying modes.

### Sources of Heat:

Fuel: Solid, Liquid or Gas-Fired (indirect only as related to the interface with bio-ingredients being processed).
Heated Water, Saturated Steam, S.H.S., and/or Oil (the latter, indirectly, as related to the interface with bio-ingredients).
Electric: arc, resistance or Induction.
Non-ionizing Electromagnetic Radiation: Microwave and/or RF.

### Heating Transmission:

Radiant, or radiated, or conduction.
Convection (Natural or Forced), through using Inert(s) and/or noble(s) gases.
Non-ionizing Electro-magnetic Radiation (e.g., RF, or microwaves).
Mixed sources of heat transferring (e.g., impingement).
   Construction Materials in Contact with the Foods:
Any structural material authorized for direct contact with food.
Of Sanitary construction, for food application.

### Equipment Construction Shapes of Forms:

Sphere.
Cylinder.
Boxes.
Tunnel-shape, using transporters such as chains, bands, or other types of conveyors.
Multiple Combinations of shapes and forms.

### Types of Process Load Assessment, i.e., Inlet & Exit Port Devices:

Removable Top Lids.
Single-Front swinging or double accessing.
Closings and/or Openings suitable for load/unload, and under vacuum operating conditions—for batch or continuous operations.

### Specific Utilization:

Primarily for Baking and/or For Other ways to Heat-Processing Foods under Vacuum Oven, vacuum-gas compensated (under- or over-gas pressurized) and/or pressurized Oven.

### Types of Processing & Operation(s):

Batch.
Continuous.
Semi-Continuous.
Manual, Semi-Automatic or Automatic.
Single Process Area (within the Equipment).
Multiple Processing Areas (within the Equipment).
Processing Stations (simple or multiple, the latter of type (e.g.): “load/pre-heat/heat/process/pre-cooling/cooling stations.”
   Food Heating/Cooling Types of Food Contact and/or Gas Patterns:
Directly, through in-process Racks, Shelves or Carts.
Indirectly, via pans or through other compartments: individuals or collectives.
Impingement: direct- or indirect gas contact.
Horizontal heated/cooled gas flow.
Horizontal & vertical (or vice-versa) heated/cooled gas flow.
Vertical/Top Down or Bottom Up heated/cooled gas flow.

### G.2.8—What are the Essential &/or Important Aspects of the Invention:

The Novel System, Modified Machinery, Alternative Processing Technology & Methods disclosed, to counterpoint the traditional processing technology, addressing & resolving the major drawback is the short life and quality of the relevant Baked-Goods segment of the global markets.

The proper solution addressing the existing concerns related to Nutritional safety and nutrient losses experienced by the Baked-Goods, when utilizing the traditional processing technology.

The consequential solution for extending quality, improving health safety, shelf-life and in reduction of Nutritional losses of Baked-Goods, with global implications in the economy of these industries, as related to industrial, commercial and storage losses, and altering the global logistics associated with this segment of the market.

H—The Patent Application Claims-Concerning this Invention Disclosed

### H.1—Recital: Basic Definitions for the Claims.

Functionality: The inventor claims herein are based on the purpose of providing alternatives (or options), related to System, Processing Technology, Equipment (Novel and/or Modified and/or Variant) and/or Method for processing selected edible bio-ingredients, and their liquor, mass, or drinkable portions-derivatives, which require roasting for their typical consumption as food and/or drink.

System: herein understood as a set of interconnected items, forming a unified whole.

Processing Technology (and/or Operation): herein understood as the execution of a sequence of actions (or steps) to achieve the desired outcome, i.e., edible finished products, able to be directly consumed as food and/or beverage-derivative products, shelf-stable for extended period of time,—provided that they have been entirely processed in the absence of atmospheric air, including (and especially) during the critical step of roasting or baking, and also stored under such conditions.

Novel and/or Modified Equipment (or Apparatus): herein understood as respectively, either any equipment that was conceptualized, designed and/or built, demonstrating innovation, creativity and/or originality, and/or had introduced innovative features and/or improvements—or had undergone alterations or adjustments,—thus (in any case) departing from the traditional norm, represented by typical, standard and/or existent equipment.

Alternate or Variant of Novel and/or Modified Equipment (or Apparatus): herein respectively understood as, different or slightly diverse features of the referred Novel or Modified Equipment, although maintained the same purpose for which was built.

Concept: The mental construct of an abstract idea, which may conduct to a plan, intention, invention or Generalization of a thought.

Method: Is a particular way or form of procedure, conducted in a systematic, classifying and/or schematizing path to accomplish a pre-established goal.

From the bio-ingredients and derivatives listed under Ref. 1 below, the Concept for processing such products, some of the equipment designed-either as Novel (the specific case of the Special Roaster and/or Oven) or Modified (in some other cases, below disclosed)—as well as the Non-Conventional Processes employed are considered as References from this document, for the sole purpose of inventive claims, and being pursued through this patent application. They are:
The List of Roasting-based processed Bio-ingredients, and edible derivative products, consumed in form of solid or liquid, listed under item B.1
The List of Bio-ingredients and/or products, listed under item B.2 and/or item H.3

### H.2—Why the Invention is Unique

By disclosing a Novel System, Modified Machinery, Alternative Processing Technology & Methods that reduce, or mitigate the important and economically relevant losses experienced by Global Roasting—and of the Baked Goods Industries, when obtained through the traditional processing technology, such as shortage of shelf-life and/or impact in reducing health-related concerns due to formation of harmful chemicals in quality and/or quantity that are formed during traditional processing technologies as compared to this Invention.

By the first time, the intrinsic problems associated with these industries, such as shorter shelf-life, health concerns, degradation of quality and losses of nutrients (such as vitamins and other heat-sensitive nutritional factors). Consequently, translated as industrial losses, and lower nutritional values, these concerns were properly tackled (and resolved) based on the alternative concept developed. As such, system, machinery, processing technology and method for processing either roasting- and/or baked goods were developed, where the exclusion of oxygen from the atmospheric air, in all phases of the process, were established, required and disclosed, and for that requiring selected novel and/or modified apparatuses and/or variations in traditional processing technologies.

As Related to the Roasting-Goods' Novel- and/or Modified Equipment, Operation, and the Processing Technology & Methods thereof for Roasted-based ingredients, Foods & their Derivative-Beverages.

### H.3—Exemplary Inventive Aspects

For the specific utilization of this Novel Concept of Roasting under absence of atmospheric air (and therefore oxygen, the target aimed at), and one of the objectives of this Patent Petition, the entire proposed process for the manufacturing process of selected bio-ingredients, namely:
Edible and/or drinkable-convertible beans, such as coffee, cocoa, and the like.
Edible and/or drinkable cocoa- and coffee derivatives, such as chocolate, coffee, tea bars & beverages, and the like.
Edible and/or drinkable-convertible nuts, such as: Coconuts, Brazil nuts, Almonds, Cashew nuts, Hazelnuts, Macadamias, Pecans, Walnuts, Peanuts, and the like; and
Edible and/or drinkable-convertible herbs and their related products (pre-fermented or not), such as: Green-Black Teas, Chamomile, Matte, Ginger, Hibyscus, and the like.

The selected bio-ingredients above, including eventual (optional) conversion for further processing in form of their liquors (or masses) (whole or partial), single or composite, concentrated or not,—aiming at preserving their organoleptic characteristics and extending their shelf lives up to their end processed products,—by using the specific concept, processing steps, equipment and/or methods disclosed in this Patent Application.

For all cases, the following criteria, processes and purposes were adopted:
utilizing selected equipment listed herein, which has been originally idealized, designed, built, and/or specially modified for the specific purposes herein described by the inventor.
employed in the following unit operation sequence of steps, as described; and
utilizing the herein pre-defined basic processing parameters, as informed.

TABLE 1
variants of the novel roaster apparatus, operating under the absence of atmospheric oxygen (air)

| ITEM | VARIANT REFERENCE | REFERENCE | TYPE OF VARIANT | REMARKS |
|---|---|---|---|---|
| 1 | OPERATING VERSION | A | UNDER VACUUM | FROM 0.001 TO <760 |
| | | | | TORR |
| | | B | COMPENSATED ATM. | USING INERT/NOBLE |
| | | | | GAS(ES) |
| | | C | UNDER PRESSURE | USING INERT/NOBLE |
| | | | | GAS(ES) |
| 2 | CONFIGURATION/ | D | CLOSED-LOOP | FOR RECOVERY OF |
| | OPERATION | | | INERT/NOBLE GAS(ES) |
| | | E | SEMI-CLOSED | FOR PARTIAL RECOVERY |
| | | | LOOP | OF INERT/NOBLE |
| | | | | GAS(ES) |
| 3 | QUENCHING SYSTEM- | F | INTERNAL | W/OR W/O TORREFACTO |
| | 1/TORREFACTO | | | CAPABILITY |
| | DEVICE/SYSTEM | G | EXTERNAL | |
| 4 | HEAT SOURCE | H | BUILT IN | |
| | LOCATION | I | EXTERNALLY TO THE | |
| | | | ROASTER | |
| 5 | DESIGN CAPACITY | J | BENCH/LAB | FROM <0.1 KG TO 10 |
| | | | | KG OF LOAD CAPACITY |
| | | K | PILOT PLANT | FROM >10 KG TO 50 KG |
| | | | | OF LOAD CAPACITY |
| | | L | COMMERCIAL/ | FROM >50 KG TO >20, 000 |
| | | | INDUSTRIAL | KG OF LOAD/RUN CAPACITY |
| 6 | TYPE OF OPERATION | M | BATCH | |
| | | N | SEMI-CONTINUOUS | |
| | | O | CONTINUOUS | |
| 7 | HEATING SOURCE/ | P | SOLID, LIQUID, GAS | COMMERCIALLY |
| | TYPE | | FUEL | AVAILABLE FUELS |
| | | Q | ELECTRIC | EXAMPLE ILLUSTRATED |
| | | | | ON FIG. 3-REF. 303 |
| | | R-S-T-U-V | NON-IONIZING | FROM FREQ.S 3 PHz TO |
| | | | RADIATION | 3 Hz/WL OF 100 nm- |
| | | | | 100 Mn |
| | | W | SHS | |
| | | X | INERT/NOBLE GAS(ES) | W/RECOVERY SYSTEM |
| 8 | CONSTRUCTION | Y | ANY METAL | AUTHORIZED FOR |
| | MATERIALS | Z | ANY ALLOY | CONSTRUCTION OF |
| | | | | FOOD PROCESSING |
| | | | | EQUIP/DIRECT- OR |
| | | | | INDIRECT CONTACT |
| | | | | WITH FOOD |
| 9 | HEATING METHOD | AA | DIRECT | COMMERCIAL FUELS, |
| | | BB | INDIRECT | NON-IONIZED |
| | | | | RADIATION, ELECTRIC |
| | | | | DIRECT- OR INDIRECT, |
| | | | | INERT/NOBLE GAS(ES) |
| | | | | DIRECT- OR INDIRECT |
| 10 | OPERATION MODE | CC | MANUAL | |
| | | DD | SEMI-AUTOMATIC | |
| | | EE | FULLY AUTOMATIC/ | |
| | | | PROGRAMABLE | |
| 11 | LOAD/DISCHARGE | FF | LOCK-IN TO THE | TO ENSURE ABSENCE |
| | SYSTEM | | APPARATUS | OF ATMOSPHERIC |
| | | | | OXYGEN (AIR) |
| 12 | HEAT SOURCE | GG | TO THE HEAT | |
| | CONDUIT | | PROCESSING DEVICE | |
| 13 | ROTARY CTL | HH | TO ALLOW CONSTANT | |
| | MECHANISM & | | ROTARY SPEED, AND | |
| | SYSTEM | | ALSO WITH POSSIBLE | |
| | | | VARIATION IN | |
| | | | ROTATION | |
| 14 | INLET GAS | II | INTER-CONNECTION | |
| | PIPE, VALVES & | | TO THE ROASTING | |
| | CTLS -1 | | EQUIPMENT | |
| 15 | INLET GAS PIPE, | JJ | INTER-CONNECTION | |
| | VALVES & CTLS-2 | | TO THE ROTARY DRUM | |
| | | | INTERNAL AREA OR | |
| | | | COMPARTMENT (OR | |
| | | | DEVICE) | |
| 16 | INLET GAS PIPE, | KK | INTER-CONNECTION | |
| | VALVES & CTLS-3 | | TO THE ROTARY DRUM | |
| | | | OR HEAT TRANSFER | |
| | | | COMPARTMENT (OR | |
| | | | DEVICE) | |
| 17 | QUENCHING SYSTEM - | LL | INSTALLED OUTSIDE | |
| | 2 | | THE ROASTER, IN THE | |
| | | | F.B.D. &/ORC. | |
| 18 | MECHANICAL DEVICE | MM | COULD BE BASED ON | |
| | FOR KYNETIC EFFECT | | VIBRATION, ROTATION, | |
| | | | TUMBLING, MIXING, | |
| | | | CHURNING, FLUID-BED | |
| | | | SUSPENSION, ETC. | |
| 19 | MANUAL/AUTOMATIC | NN | TO ALLOW SAMPLE AT | |
| | SAMPLE SUPPLY | | ANY TIME OF THE | |
| | DEVICE/SYSTEM | | ROASTING PROCESS, | |
| | | | BE IT UNDER VACUUM, | |
| | | | UNDER ATMOSPHERE- | |
| | | | COMPENSATED OR | |
| | | | UNDER PRESSURE | |

TABLE 2
Variants of the novel oven apparatus, operating under the absence of atmospheric oxygen (air)

| | VARIANT | | | |
|---|---|---|---|---|
| ITEM | REFERENCE | REFERENCE | TYPE OF VARIANT | REMARKS |
| 1 | OPERATING | A | UNDER VACUUM | FROM 0.001 to <760 Torr |
| | VERSION | B | COMPENSATED ATM. | USING INERT/NOBLE GAS(ES) |
| | | C | UNDER PRESSURE | USING INERT/NOBLE GAS(ES) |
| 2 | CONFIGURATION/ | D | CLOSED-LOOP | FOR RECOVERY OF |
| | OPERATION | | | INERT/NOBLE GAS(ES) |
| | | E | SEMI-CLOSED LOOP | FOR PARTIAL RECOVERY OF |
| | | | | INERT/NOBLE GAS(ES) |
| 3 | QUENCHING | F | INTERNAL | W/ OR W/O TORREFACTO |
| | SYSTEM-1/ | | | CAPACITY |
| | TORREFACTO | G | EXTERNAL | |
| | DEVICE/SYSTEM | | | |
| 4 | HEAT SOURCE | H | BUILT IN | |
| | LOCATION | I | EXTERNALLY TO THE | |
| | | | ROASTER | |
| 5 | DESIGN | J | Bench/lab | FROM <0.1 KG TO 10 KG OF |
| | CAPACITY | | | LOAD CAPACITY |
| | | K | PILOT PLANT | FROM >10 KG TO 50 KG OF |
| | | | | LOAD CAPACITY |
| | | L | COMMERCIAL/ | FROM >50 KG TO >20, 000 KG |
| | | | INDUSTRIAL | OF LOAD/RUN CAPACITY |
| 6 | TYPE OF | M | BATCH | |
| | OPERATION | N | SEMI-CONTINUOUS | |
| | | O | CONTINUOUS | |
| 7 | HEATING | P | SOLID, LIQUID, GAS FUEL | COMMERCIALLY AVAILABLE |
| | SOURCE/TYPE | | | FUELS |
| | | Q | ELECTRIC | EXAMPLE ILLUSTRATED ON FIG. |
| | | | | 3-REF. 303 |
| | | R-S-T-U-V | NON-IONIZING RADIATION | FROM FREQ.S 3 PHz TO 3 Hz/ |
| | | | | WL 100 nm-100 Mn |
| | | W | SHS | |
| | | X | INERT/NOBLE GAS(ES) | W/RECOVERY SYSTEM |
| 8 | CONSTRUCTION | Y | ANY METAL | AUTHORIZED FOR |
| | MATERIALS | Z | ANY ALLOY | CONSTRUCTION OF FOOD |
| | | | | PROCESSING EQUIP/DIRECT- |
| | | | | OR INDIRECT CONTACT WITH |
| | | | | FOOD |
| 9 | HEATING | AA | DIRECT | NON-IONIZED RADIATION, |
| | METHOD | BB | INDIRECT | ELECTRIC DIRECT- OR INDIRECT, |
| | | | | INERT/NOBLE GAS(ES) DIRECT- |
| | | | | OR INDIRECT |
| 10 | OPERATION | CC | MANUAL | |
| | MODE | DD | SEMI-AUTOMATIC | |
| | | EE | FULLY AUTOMATIC/ | |
| | | | PROGRAMABLE | |
| 11 | LOAD/ | FF | LOCK-IN TO THE | TO ENSURE ABSENCE OF |
| | DISCHARGE | | APPARATUS | ATMOSPHERIC OXYGEN (AIR) |
| | SYSTEM | | | |
| 12 | HEAT SOURCE | GG | TO THE HEAT PROCESSING | |
| | CONDUIT | | DEVICE | |
| 13 | ROTARY CTL | HH | TO ALLOW CONSTANT | |
| | MECHANISM & | | ROTARY SPEED, AND ALSO | |
| | SYSTEM | | WITH POSSIBLE VARIATION | |
| | | | IN ROTATION | |
| 14 | INLET GAS | II | INTER-CONNECTION TO | |
| | PIPE, VALVES & | | THE OVEN EQUIPMENT | |
| | CTLS -1 | | | |
| 15 | INLET GAS PIPE, | JJ | INTER-CONNECTION TO | |
| | VALVES & CTLS- | | THE OVEN INTERNAL AREA | |
| | 2 | | OR COMPARTMENT (OR | |
| | | | DEVICE) | |
| 16 | INLET GAS PIPE, | KK | INTER-CONNECTION TO | |
| | VALVES & CTLS- | | THE HEAT TRANSFER | |
| | 3 | | COMPARTMENT (OR | |
| | | | DEVICE) | |
| 17 | QUENCHING | LL | INSTALLED OUTSIDE THE | |
| | SYSTEM - 2 | | OVEN, IN THE F.B.D. &/ORC. | |
| 18 | MECHANICAL | MM | COULD BE BASED ON | |
| | DEVICE FOR | | VIBRATION, ROTATION, | |
| | KYNETIC EFFECT | | TUMBLING, MIXING, | |
| | | | CHURNING, FLUID-BED | |
| | | | SUSPENSION, ETC. | |
| 19 | MANUAL/ | NN | TO ALLOW SAMPLE AT ANY | |
| | AUTOMATIC | | TIME OF THE OVEN | |
| | SAMPLE SUPPLY | | PROCESS, BE IT UNDER | |
| | DEVICE/SYSTEM | | VACUUM, UNDER | |
| | | | ATMOSPHERE- | |
| | | | COMPENSATED OR UNDER | |
| | | | PRESSURE | |
| 20 | OTHER SPECIFIC | OO | IN ACCORDANCE WITH THE | |
| | FEATURES, | | DESCRIPTIONS FROM | |
| | CHARACTERISTICS | | [00324] TO [00393], AS | |
| | AND/OR | | LISTED IN THE PATENT | |
| | DEVICES | | APPLICATION. | |
| | RELATED TO THE | | | |
| | OVEN | | | |
| | APPARATUS | | | |

TABLE 3
Details of the Sources of Heating, which may be utilized for both novel roaster
& oven apparatuses, operating under the absence of atmospheric oxygen (air):

| | | FREQUENCY | WAVELENGHT | |
|---|---|---|---|---|
| | | RANGE OF THE | RANGE OF THE | |
| SOURCE OF | | ELECTROMAGNETIC | ELECTROMAGNETIC | |
| HEAT | TYPE/APPLICATION | SPECTRUM | SPECTRUM | REMARKS |
| ANY SOLID, | DIRECT- AND/OR INDIRECT | N.A. | N.A. | ANY COMMERCIALLY |
| LIQUID OR GAS | BURNING/INDIRECT- | | | AVAILABLE & |
| FUELS | ONLY FOR FOOD | | | AUTHORIZED FOR |
| | CONTACT, THROUGH | | | FOOD APPLICATION. |
| | MEANS OF CONDUCTION, | | | |
| | CONVECTION, AND/OR | | | |
| | THERMAL RADIATION | | | |
| ELECTRICITY | DIRECT- AND/OR INDIRECT | N.A. | N.A. | ANY SUITABLE |
| | | | | VOLTAGE AVAILABLE |
| | | | | & POTENCY |
| | | | | ACCORDING TO THE |
| | | | | DESIGN CAPACITY OF |
| | | | | THE APPARATUSES. |
| RF (RADIO | DIRECT- AND/OR INDIRECT | 3 kHz-300 | 1 mm-100 Km | MORE SPECIFICALLY, |
| FREQUENCIES) | | MHz (or 10⁴ | (or 10³ m − | AT FREQUENCES OF: |
| | | Hz-10¹⁵ Hz) | 0.5 × 10⁻⁶ Hz) | 13.56 MHz, |
| | | | | 27.12 MHz and |
| | | | | 40.68 MHz. |
| MICROWAVES | DIRECT- AND/OR | 300 GHz- | 1 mm-1 m | MORE SPECIFICALLY, |
| | INDIRECT, AND REQUIRES: | 300 THz | | AT FREQUENCES OF: |
| | (1) GENERATOR | | | 915 MHz (SMALL, |
| | (MAGNETRON); (2) WAVE | | | AND/OR |
| | GUIDE; AND (3) FOOD | | | COMMERCIAL |
| | COMPARTMENT (FOR | | | APPLICATION- |
| | CONTAINMENT & WAVES' | | | 2.45 GHz (INDUSTRIAL |
| | INNER- REFLECTION) | | | APPLICATION), AND |
| | | | | 600 W −> 100 KW, |
| | | | | DEPENDING ON THE |
| | | | | EQUIPMENT |
| | | | | CAPACITY. |
| I.R. (INFRA- | DIRECT- AND/OR | 300 THz-400 | 0.78 μm.-1,000 | |
| RED) | INDIRECT, INCLUDING: (1) | THz | μm. | |
| | NIR; (2) MIR; AND (3) FIR | | | |
| VISIBLE LIGHT | DIRECT- AND/OR INDIRECT | 400 THz- 800 | 100 nm-100 | |
| | | THz | Mm | |
| SUMMARY: | DIRECT- OR INDIRECT | 10⁴ Hz-10¹⁵ Hz | 103 m − | MORE SPECIFICALLY, |
| WHOLE NON- | | | 0.5 × 10⁻⁶ m | AT FREQUENCES OF: |
| IONIZING | | | | 3 PHz-3 Hz. |
| SPECTRUM OF | | | | (CONTINUATION) |
| E.R. SPECTRUM | | | | |
| OF INTEREST | | | | |
| FOR USE IN | | | | |
| THESE | | | | |
| DISCLOSED | | | | |
| APPARATUSES. | | | | |

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention, as claimed.

What is claimed is:

1. A method for preparing baked products from raw materials, comprising a baking step in which the raw materials are subjected to baking in the absence of atmospheric oxygen.

2. The method of claim 1, comprising alternative processing technology and methods, comprising:
an modified oven having a sealed rotary, or stationary baking shelves (or processing compartment), configured to sustain or bake the raw materials or pre-processed foods in the absence of atmospheric oxygen.
a discharge cyclone connected to a feeding system for feeding the raw materials or pre-processed foods into a front end of the baking shelves (or processing compartment).
a heat source configured to directly or indirectly heat the baking shelves or directly the pre-processed foods, sustained by the shelves (or processing compartment).
a rotation device, with rotation control configured to rotate the baking shelves (or processing compartment), or a sustainment device to support the pre-processed foods, while submitted to the roasting process.
an inert gas inlet pipe connected to the baking shelves (or processing compartment). for supplying pre-heated inert gas to the baking shelves (or processing compartment), or to the internal heat exchanger responsible for heating the gas medium during the baking process.
an inert gas outlet pipe connected to the first end of the baking shelves (or processing compartment), for receiving inert gas exiting the baking shelves (or processing compartment) and directing the inert gas for processing; and
redistribution to the inert gas(es)′ inlet pipe.

3. The method of claim 1, further comprising a milling step performed consecutively after the baking step.

4. The method of claim 1, wherein the absence of atmospheric oxygen is achieved using a vacuum, vacuum-compensated, or pressured, by using an inert atmosphere.

5. The method of claim 4, further comprises storing the baked products in the absence of atmospheric oxygen.

6. The method of claim 4, wherein the method further comprises providing an alternative processing technology and methods comprising:
a roaster having a sealed rotary roasting drum (or processing compartment), configured to bake the raw materials in the absence of atmospheric oxygen.
a discharge cyclone connected to a feeding system for feeding the raw materials into a front end of the roasting drum (or processing compartment).
a heat source configured to directly or indirectly heat the roasting drum (or processing compartment).
a rotation device with rotation control configured to rotate the roasting drum (or processing compartment).
an inert gas inlet pipe connected to the roasting drum (or processing compartment). for supplying pre-heated inert gas to the roasting drum (or processing compartment)
an inert gas outlet pipe connected to a first end of the roasting drum (or processing compartment), for receiving inert gas exiting the roasting drum (or processing compartment) and directing the inert gas for processing; and
redistribution to the inert gas(es)' inlet pipe.

7. The method of claim 6, further comprising:
feeding the raw materials into the sealed rotary roasting drum (or processing compartment).
heating the roasting drum (or processing compartment).
rotating the roasting drum (or processing compartment) while heating; and
circulating pre-heated inert gas into the roasting drum (or processing equipment) while roasting the raw materials.

8. The method of claim 7, further comprising recycling the inert gas pumped into the roasting drum (or processing equipment) for reuse.

9. The method of claim 6, wherein the assembly further comprises one or more of: mixers, conveyors, feeding hoppers, silos, and dough-handling equipment, all configured to operate in the absence of atmospheric oxygen.

10. The method of claim 6, further comprising:
transferring the baked products to a fluid-bed cooler configured to operate in the absence of atmospheric oxygen; and
cooling the baked products to ambient temperature in the absence of oxygen.

11. The method of claim 10, wherein the fluid-bed cooler comprises:
a mechanical vibratory screen for transporting the baked products under an upstream impingement flow of cool gas; and
a cryogenic pre-grinder for grinding the baked products.

12. The method of claim 6, further comprising spraying fluid onto the baked products in the absence of atmospheric oxygen, the fluid comprising an edible organic compound.

13. The method of claim 12, wherein the fluid comprises a sweetener in a cooled water solution, and addition of the solution during a pre-cooling stage of post-roasting produces a torrefacto effect.

14. The method of claim 6, further comprising cryogenic pre-milling of the raw materials in the absence of atmospheric oxygen.

15. The method of claim 6, further comprising:
extracting one or more ingredients from the raw materials.
preserving one or more ingredients; and
re-incorporating the one or more ingredients into the baked products.

16. The method of claim 16, wherein one or more ingredients comprises oils extracted using liquid carbon dioxide under supercritical conditions.

17. A method for preparing baked products from raw materials, comprising a baking or roasting step performed in an inert atmosphere.

18. The method of claim 17, further comprising a milling step performed consecutively after the baking or roasting step.

19. A processing technology for preparing baked products, comprising a plurality of unit operations including milling and baking, wherein the milling and baking are performed in the absence of atmospheric oxygen.
